(19) United States
(12) Patent Application Publication
(10) Pub. No.: US 2025/0130145 A1
(43) Pub. Date: Apr. 24, 2025

(54) DEVICES, SYSTEMS AND METHODS FOR SAMPLE COLLECTION, TRANSPORT, AND CONCENTRATION OF TARGET PARTICLES FROM LIQUIDS

(71) Applicant: INNOVAPREP LLC, Drexel, MO (US)

(72) Inventors: Andrew E. Page, Smithton, MO (US); John D. Birkenholz, Kansas City, MO (US); Alec D. Adolphson, Raymore, MO (US); David Goad, Stillwater, OK (US)

(21) Appl. No.: 18/926,159

(22) Filed: Oct. 24, 2024

Related U.S. Application Data
(60) Provisional application No. 63/545,385, filed on Oct. 24, 2023.

(51) Int. Cl. G01N 1/40; B01D 69/06; B01D 69/08

(52) U.S. Cl. CPC G01N 1/4005; B01D 69/06; B01D 69/08

(57) ABSTRACT

The subject disclosure relates generally to the field of sample preparation. More particularly, the subject disclosure relates to devices, systems and methods for processing large liquid volumes through a concentrating pipette tip whereby targeted particles or large molecules are captured onto an internal membrane filter. The concentrating pipette tip is then packaged for transport to a facility or laboratory for subsequent elution into a small volume of buffer for analysis. The disclosed system simplifies sample transport while also enhancing the sensitivity of subsequent analysis methods.

This patent application claims priority to U.S. Provisional Patent Application Ser. No. 63/545,385, filed Oct. 24, 2023; the contents of which are hereby incorporated by reference herein in their entirety into this disclosure.

### BACKGROUND OF THE SUBJECT DISCLOSURE

### Field of the Subject Disclosure

The subject disclosure relates generally to the field of sample preparation. More particularly, the subject disclosure relates to devices, systems and methods for processing large liquid volumes through a concentrating pipette tip or membrane filter module whereby targeted particles or large molecules are captured onto an internal membrane filter or plurality of membrane filters. The concentrating pipette tip or membrane filter module is then packaged for transport to a facility or laboratory for subsequent elution into a small volume of buffer for analysis. The disclosed system simplifies sample transport while also enhancing the sensitivity of subsequent analysis methods.

### Background of the Subject Disclosure

Many life science, environmental science, microbiome research, disease surveillance and other scientific fields and applications have a need for improved methods for sensitive detection and identification of biological and non-biological particles and large molecules found in liquid samples. Further, these particles are often found in such low concentrations that it is necessary to collect and then cold transport large liquid sample volumes from remote or field locations to laboratories that are able to perform the sample concentration, extraction and analysis methods.

In these applications, sample collection, sample transport, and concentration of target particles are separate steps that are used together, and each has its own complexities and inefficiencies that create a less than ideal system.

### SUMMARY OF THE SUBJECT DISCLOSURE

The present subject disclosure combines these separate processes into a technique that is capable of providing a final higher concentration of target particles and reduces sample collection and transport complexities and cost.

In the case of detection and identification of environmental pathogens and indicator organisms such as E. coli, Cryptosporidium, Legionella spp., Vibrio spp., Enterococcus spp., coliphage and others, they are often found in extremely dilute concentrations that create a requirement for collection and transport of very large sample volumes. Sample volumes ranging from 5 mL to as much as 1,000 Liters, or more commonly from 25 mL to 100 Liters, are collected and must then be transported, generally overnight, on wet ice to ensure sample quality is maintained. Sample volumes of these sizes can require considerable equipment, consumables, and labor to collect and require large ice chests or insulated packaging and wet ice for transport, which must be shipped using next day or 2nd day shipping to ensure the required temperature is maintained. Finally, these samples generally must still go through a sample concentration process after receipt before the samples can be extracted and analyzed.

After receipt of large liquid samples such as, for example, 1 Liter environmental water samples by the laboratory, they are often processed using a 47 mm, 0.2 μm membrane filter that is placed into a vacuum filter funnel. The membrane filter is then removed from the filter funnel using two forceps and is loosely rolled or folded and placed into a bead beater tube containing beads. The filter is then bead beat to remove and lyse target particles. The sample must then go through nucleic acid extraction and real-time quantitative polymerase chain reaction, real-time quantitative reverse transcriptase polymerase chain reaction, sequencing or other appropriate analysis approach.

A range of other approaches for molecular detection or growth-based detection of target microorganisms or other particles is possible. Other membrane filter configurations or other types of concentration methods are used for other targets, but nearly all environmental microbiology related methods require cold transport of large liquid volumes followed by concentration, extraction, and analysis.

Another common method is termed environmental DNA or eDNA, which generally uses microfilter pore size of a 47 mm filter or a Millipore Sterivex or Sterivex-HV filter to collect cells and cellular debris from environmental waters to assist in determining the presence or absence of specific organisms based on the presence or absence of associated DNA. The approaches often require complex filter or liquid sample handling in the field prior to stabilization and/or shipment on wet ice. The sample is then generally concentrated in the laboratory or the filter is extracted in the laboratory using complex, generally manually, procedures. The DNA is then extracted and is analyzed using molecular techniques.

With the disclosed approach, a pump, or in the case of sampling from water lines a regulator, is used, to push or pull a sample volume through a concentrating pipette tip or other hollow fiber or flat membrane filter concentration module. The concentrating pipette tip or membrane filter module is then either capped and placed into a cold shipment package or a preservation, stabilization, or transport media is pushed into the tip with a syringe and the tip is then capped and shipped at room temperature or in cold packaging if longer transport times are required. Alternatively, the pump may be used to allow a transport media to be drawn or pushed into the tip from a container, so that the remaining internal liquid volume in the tip may be made mostly of transport media. When received by the laboratory the top caps are removed from the concentrating pipette tip and it is inserted into a concentrating pipette instrument, or a dedicated elution instrument, to elute the sample or the transport media is removed using a syringe or pushed out by air or a liquid that is pushed into the concentrating pipette tip. Additionally, prior to elution using the concentrating pipette, wash steps may be performed to assist in removal of natural organic matter, including humic substances, or other inhibitory materials and to improve recovery of target particles prior to the final elution being performed. The samples are then extracted and analyzed using molecular, growth, flow cytometry, electrochemical, or other rapid or culture-based analysis methods that will be well known to those skilled in the art.

The approaches described within this disclosure can be performed either with a concentrating pipette tip or an alternative design of a membrane filter module. The present disclosure addresses the problem outlined and advances the art by providing an efficient, simple, low-cost approach for collection of target particles, microorganisms, viruses, or large molecules onto a membrane filter device prior to stabilization and/or cold shipment and elution of the concentrated sample in a laboratory prior to extraction and analysis.

### BRIEF DESCRIPTION OF THE DRAWINGS

FIGS. 1-16 provide descriptions of a concentrating pipette tip (CPT) and the use of it and other membrane filter devices as part of the disclosed system and method for sample collection, transport, and concentration of target particles from liquids. FIG. 17 shows an exemplary subscription program.

FIG. 1 shows an external view of a CPT having hollow fiber membrane filters, according to an exemplary embodiment of the present subject disclosure.

FIG. 2 shows an external view of a CPT having hollow fiber membrane filters with transport caps in place, according to an exemplary embodiment of the present subject disclosure.

FIG. 3 shows an external view of a CPT having hollow fiber membrane filters with transport caps removed and shown next to the CPT, according to an exemplary embodiment of the present subject disclosure.

FIG. 4 shows an external view of a CPT sampling assembly with a CPT having hollow fiber membrane filters which is connected to a push-to-connect type fitting with a hose barb attached to the CPT outlet, according to an exemplary embodiment of the present subject disclosure.

FIG. 5 shows an external view of a CPT sampling assembly having a CPT with hollow fiber membrane filters connected to a push-to-connect type fitting and length of flexible tubing attached to the CPT outlet, according to an exemplary embodiment of the present subject disclosure.

FIG. 6 shows an external view of a CPT sampling assembly having a CPT with hollow fiber membrane filters with a length of flexible tubing attached to the CPT permeate port, according to an exemplary embodiment of the present subject disclosure.

FIG. 7 shows an external view of a CPT sampling assembly having CPT with hollow fiber membrane filters attached to a push-to-connect type fitting and a preset water pressure regulator attached to the CPT sample port, according to an exemplary embodiment of the present subject disclosure.

FIG. 8 shows a push-to-connect type fitting with a garden hose threaded or NPT threaded connector, according to an exemplary embodiment of the present subject disclosure.

FIG. 9 shows a preset water pressure regulator, according to an exemplary embodiment of the present subject disclosure.

FIG. 10 shows an external view of a CPT sampling assembly with a CPT having hollow fiber membrane filters connected to a push-to-connect type fitting and an adjustable water pressure regulator attached to the CPT sample port, according to an exemplary embodiment of the present subject disclosure.

FIG. 11 shows an external view of a sample storage system for filling a CPT, having hollow fiber membrane filters, with a transport buffer using a push-to-connect type fitting and transport buffer syringe attached to the CPT sample port, according to an exemplary embodiment of the present subject disclosure.

FIG. 12 shows an external view of a shipping assembly for a CPT having hollow fiber membrane filters with transport caps in place and placed into a foam packaging insert, according to an exemplary embodiment of the present subject disclosure.

FIG. 13 shows a Concentrating Pipette instrument with a CPT having hollow fiber membrane filters with a transport cap on the CPT sample port, according to an exemplary embodiment of the present subject disclosure.

FIG. 14 shows an external view of a sample recovery system for recovering concentrated samples from a CPT, having hollow fiber membrane filters, with a push-to-connect type fitting and sample recovery syringe attached to the CPT sample port, according to an exemplary embodiment of the present subject disclosure.

FIG. 15 shows an external view of a large volume sampling assembly having a large volume concentration module with hollow fiber membrane filters, with transport caps in place, according to an exemplary embodiment of the present subject disclosure.

FIG. 16 shows an external view of a recovery system for a large volume concentration module having hollow fiber membrane filters with permeate port transport caps in place with an elution in progress, according to an exemplary embodiment of the present subject disclosure.

FIG. 17 shows a flow schematic of a sample analysis subscription program using ship-tip CPTs, according to an exemplary embodiment of the present subject disclosure.

### DETAILED DESCRIPTION OF THE SUBJECT DISCLOSURE

The subject disclosure relates to devices, systems and methods for processing large liquid volumes through a concentrating pipette tip or membrane filter module whereby targeted particles or large molecules are captured onto an internal membrane filter or plurality of membrane filters. The concentrating pipette tip or membrane filter module is then packaged for transport to a facility or laboratory for subsequent elution into a small volume of buffer for analysis. The disclosed system simplifies sample transport while also enhancing the sensitivity of subsequent analysis methods.

Under the subject disclosure concentrating pipette tips and other membrane filter modules can be used to capture microorganisms of interest in a location away from where the final analysis will take place. This approach allows for collection of the target microorganisms into the concentrating pipette tip or membrane filter module, and subsequent transport to the laboratory, rather than transporting a large liquid volume.

With either the concentrating pipette tip or other membrane filter modules, a pressure pump, suction pump, gravity pressure, or pressure from a reservoir, water line, or other pressurized source, may be used to push or draw the sample through the device. After collection the device may then be immediately transported to the laboratory if the laboratory location is close-by, or the sample may be shipped to the laboratory. Depending on the transport or shipping time period, the sample may be transported at room temperature, on wet ice, on dry ice, or by other cold storage techniques that will be well known by those skilled in the art.

Further, the sample may also be stabilized by adding a volume of a transport buffer to the device, or completely filling the device with a transport buffer, before transport. In this case it may be possible to transport the sample at room temperature while still maintaining the viability or infectivity of target microorganisms or while maintaining analysis targets, including molecular and other targets, from degradation.

The present subject disclosure incorporates the use of the concentrating pipette instrument for performing complex sample manipulation and concentration steps within a disposable concentrating pipette tip. The concentrating pipette instrument may be used in the field for collection onto concentrating pipette tips prior to transport to a laboratory for elution and subsequent analysis. Alternatively, a pressure pump, suction pump, gravity pressure, or pressure from a reservoir, water line, or other pressurized source, may be used to push or draw the sample through the device.

All conduits by which the disposable concentrating pipette tip attaches to the concentrator unit instrument are combined into a single connection point on the upper end of the concentrating pipette tip. The concentrating pipette tip (CPT) works with a system including a concentrator unit and a liquid sample. To operate the system, a new clean concentrating pipette tip is attached to the concentrator unit and the lower opening of the concentrating pipette tip is dipped into a liquid sample contained in an appropriate sample container and the concentrator unit is activated. The use of a new clean concentrating pipette tip ensures that there is no sample-to-sample carryover. The sample is then aspirated into the CPT where it comes into contact with a filter. The liquid is passed through the filter while particles and molecules larger than the filter pore size are captured and retained. In a standard use case, when the entire sample has passed through the filter, removing the fluid and leaving the captured material, the lower opening of the tip is placed into an appropriate sample container and an elution fluid or foam is used to elute the captured material and dispense it in a reduced volume. In the case of the present subject disclosure, however, the CPT may be removed from the instrument, capped, and transport buffer may be added to the CPT if desired, and it may then be transported to the laboratory for elution once received.

It is also possible to perform wash steps, labeling steps, cell lysis, or other manipulation by pushing a small volume of fluid into the fiber lumen, drawing it out through the filter wall or leaving it in the fiber lumen for a period of time prior to drawing it out. These techniques may be used as part of the current subject disclosure, and are especially useful for performing wash steps and injection of transport buffers prior to removal for transport to the laboratory.

After receipt at the laboratory, the CPT may be placed back into a concentrating pipette instrument and eluted into a small final sample volume. Additionally, it is also possible to perform wash steps, labeling steps, cell lysis, or other manipulation before eluting if desired. After being dispensed, the concentrated sample may be further concentrated prior to analysis by immunomagnetic separation, electrophoretic or dielelectrophoretic separation techniques, or other microfluidic concentration techniques. In many instances these techniques are useful but are in general not possible with larger volumes or are prohibitively costly or slow when performed on large volumes. By rapidly performing an initial concentration with the CPT the sample volume is reduced to a volume that is more readily handled with these techniques.

It is further possible to apply additional sample preparation techniques to the concentrated sample once dispensed. Additional sample preparation techniques that may be applied include various methods of cell lysis, washing steps, inhibitor or interferent removal techniques, and labeling steps. Reduction of the sample volume prior to performing these techniques routinely improves the speed and efficiency, while reducing the cost of performing these techniques.

Analysis of the concentrated sample may be performed with any number of commonly used traditional analytical or microbiological analysis methods or rapid analysis techniques including rapid microbiological techniques. Analytical techniques of special interest include conventional methods of plating and enumeration, most probable number, immunoassay methods, polymerase chain reaction (PCR), electrochemical, microarray, flow cytometry, biosensors, lab-on-a-chip, and rapid growth based detection technologies to name a few.

Microorganisms including pathogens and spoilage organisms may be concentrated from any number of beverages including fruit juices, vegetable juices, carbonated beverages, alcoholic beverages and from homogenates or liquid samples produced from solid foods. By concentrating large sample volumes in the range of 1 mL to 10 L or more prior to analysis it is possible to rapidly detect microorganisms at levels that were previously only detectable following lengthy culturing of a portion of the sample.

It is further possible to test samples resulting from manual swabbing of surfaces onto wetted swabs, pads, or pieces of filter material often taken for bioterrorism security monitoring. The samples are typically extracted into a volume of liquid resulting in a 2 to 20 mL volume initial sample. Samples like these may be quickly concentrated to much smaller volumes in the range of 4 to 400 μL such that agents may more easily be detected.

In still other aspects, samples may be concentrated for water sampling in search of bioterrorism agents, or in the interest of public health and safety, especially where a sample may contain target agent(s) that are thought to be a threat to the health of humans, animals or plants, causing societal disruption and economic harm. Agricultural products and livestock environments may also be evaluated by the instrumentalities herein disclosed.

Forensic sciences may also benefit from the present subject disclosure by allowing for detection of DNA collected from large surfaces, articles of clothing, air samples, liquids or other forensic type samples. Touch DNA and low-template DNA techniques can be further extended by concentrating large sample volumes into volumes more closely matching the analysis volume. Maintaining the integrity of molecular markers may be better performed by first collecting the target materials onto a concentrating pipette tip or membrane filter module, thereby removing it from its original sample fluid, and adding a transport media to the collected sample prior to transport.

These types of sampling and analysis are advantageously performed for the fields of homeland security, corporate security, and military force protection. Additional fields of use include medical research and diagnostics. For example, sample concentration is useful in determining if catheters or other medical devices are contaminated with bacteria. These devices routinely become contaminated in the hospital setting. However, it is often difficult to determine which device is causing an infection. Concentration of wash fluid from these devices allows for rapid detection of the infecting organism. Sample concentration is useful in cancer research where very low concentrations of experimental drugs in body fluids or urine are the targets of analysis, and in allergy diagnosis where low quantities of specific antigens are the targets of analysis in body fluids. Health effects research may also benefit by determining health effects known to be caused by various materials in inhaled particulate matter with aerodynamic diameter below 2.5 microns (PM 2.5). Benefits are evident in the field of forensic medicine where low concentrations of DNA, toxins, poisons, or venoms are the targets of analysis in body fluids. Other aspects of use may include the study of operating rooms for surface extraction and air monitoring of pathogens, as well as pharmaceutical manufacturing where the biological aerosol particulate matter concentration is regulated by the United States Food and Drug Administration.

The utility of the current subject disclosure was demonstrated in an example by processing 1 Liter water samples that were artificially spiked with approximately 69 CFU/mL of Pseudomonas aeruginosa. The samples were then processed by either a standard concentrating pipette method with a 0.2 μm pore size hollow fiber concentrating pipette tip, with elution immediately after processing, or by processing and then removing the 0.2 μm concentrating pipette tip and storing at 4° C. for 24 hours before placing back onto the concentrating pipette instrument for elution. While the capture and recovery efficiency was lower after storage at 4° C. for 24 hours, the elution volumes were also lower, and the calculated concentrating factor was higher for the stored tip.

TABLE 1
Example of Use

| | | | | | ShipTip, stored at 4° C, eluted 24 | | | |
|---|---|---|---|---|---|---|---|---|
| | Standard CP Select (Control) | | | | hours later | | | |
| | 1 | 2 | 3 | 4 | 5 | 6 | 7 | 8 |
| Sample | | | | | | | | |
| Volume, ml | 1000 | | | | | 1000 | | |
| Titer, CFU/ml | 6.9E+01 | | | | | 6.9E+01 | | |
| Concentrate | | | | | | | | |
| Volume, ml | 0.535 | 0.582 | 0.582 | 0.508 | 0.240 | 0.306 | 0.260 | 0.214 |
| Titer, CFU/ml | 5.9E+04 | 4.5E+04 | 3.7E+04 | 3.7E+04 | 5.3E+04 | 5.3E+04 | 6.4E+04 | 3.6E+04 |
| Efficiency, % | 46.3% | 38.4% | 31.7% | 27.1% | 18.6% | 23.8% | 24.2% | 11.2% |
| Concentration | 865 | 659 | 545 | 534 | 774 | 779 | 929 | 526 |
| Factor | | | | | | | | |

For the following description, it can be assumed that most correspondingly labeled structures across the figures (e.g., 132 and 232, etc.) possess the same characteristics and are subject to the same structure and function. If there is a difference between correspondingly labeled elements that is not pointed out, and this difference results in a non-corresponding structure or function of an element for a particular embodiment, then that conflicting description given for that particular embodiment shall govern.

In the following figures, there will be shown and described multiple configurations of disposable concentrating pipette tips which may be used to concentrate biological particles into a reduced liquid volume.

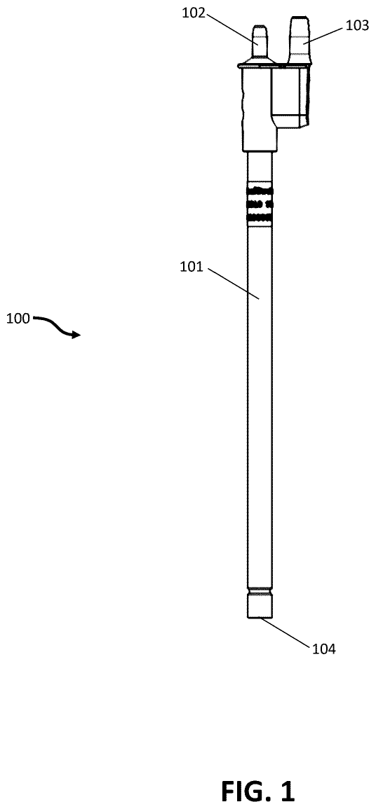

FIG. 1 shows an external view of CPT 100 having hollow fiber membrane filters, according to an exemplary embodiment of the present subject disclosure. CPT 100 comprises a filter housing 101, an elution fluid or retentate port 102, a permeate port 103, and a sample port 104. Although a hollow fiber membrane filter CPT is shown, there is no significant difference in operations of a CPT having a flat membrane filter. A flat filter CPT also has an external filter housing, an elution fluid port, a permeate port, and a sample port and collection, transport and elution can be performed in the same fashion as that of the hollow fiber CPT. The only major difference is that current flat filter CPT designs will require different cap, fitting, and tubing sizes, as appreciated by one having ordinary skill in the art.

When used along with a Concentrating Pipette (CPT) instrument, in its standard use case, the elution fluid or retentate port 102 and the permeate port 103 of CPT 100 are placed into a head manifold on the Concentrating Pipette instrument. The sample port 104 is then lowered into a liquid sample and a vacuum is pulled on permeate port 103 by the instrument. The liquid sample is then aspirated into the retentate chamber created by the lumen of the hollow fiber membrane filters. The liquid then flows through the wall of the membrane filters and into the permeate chamber, inside of filter housing 101, and into the instrument through permeate port 103. After the sample has been processed, air is drawn into the retentate which causes the hollow fiber membrane filters to lock-up because the bubble point of the hydrophilic membrane filters is not exceeded. The instrument then alerts the user that the run is complete and the user places a sample container under sample port 104 and selects to elute on the instrument user interface and a wet foam is injected into elution or retentate port 102 and travels down the retentate chamber and is dispensed out of sample port 104 and into the sample container.

In the case of the disclosed system, CPT 101 can be sampled onto, in the field, using one of several disclosed positive pressure or negative pressure sampling approaches and is then capped and transported on ice to a laboratory for elution on the Concentrating Pipette instrument. Alternatively, after sampling, CPT 101 can be filled with a transport buffer using a syringe or other means. One method of filling CPT 101 with transport buffer is immediately after sampling, but before drawing air into CPT 101, the sampling pump is turned off and when liquid stops flowing through CPT 101, sample port 104 is removed from the sample fluid and placed into a container of transport buffer, the pump is then turned back on and the transport buffer fluid is drawn into CPT 101. CPT 101 is then capped and transported to a laboratory where the sample is withdrawn using a syringe or CPT 101 is placed into the Concentrating Pipette instrument for elution. After elution the sample can be processed using a range of culture, molecular, sequencing, or other techniques and analysis methods, as will be well understood by those skilled in the art.

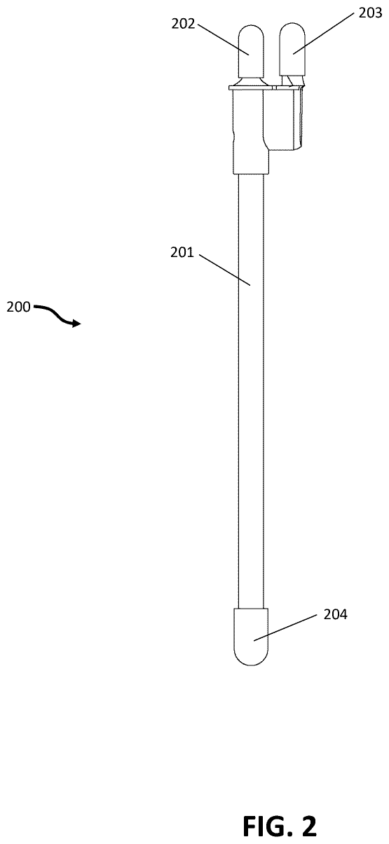

FIG. 2 shows an external view of CPT 200 having hollow fiber membrane filters with transport caps in place, according to an exemplary embodiment of the present subject disclosure. CPT 200 comprises a filter housing 201, an elution fluid or retentate port (hidden from view), a permeate port (hidden from view), and a sample port (hidden from view). In place over the ports are three transport caps, an elution or retentate port cap 202, a permeate port cap 203, and a sample port cap 204. The caps can be placed over the three ports when shipping CPTs to customers for use or when shipping back from the customer after sampling. The caps can also be used for closing off one or more ports while processing samples.

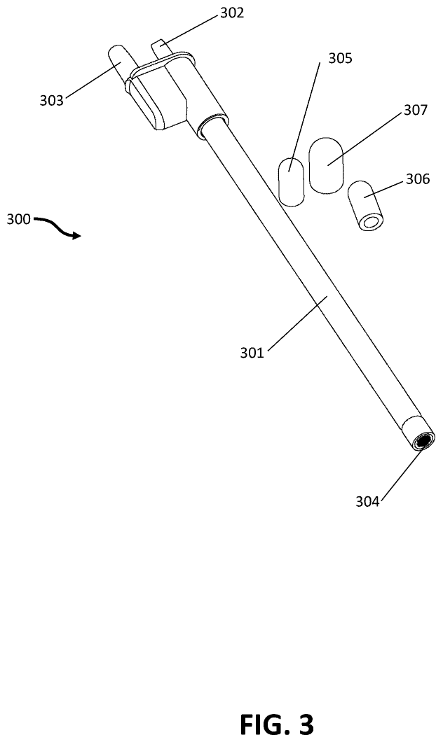

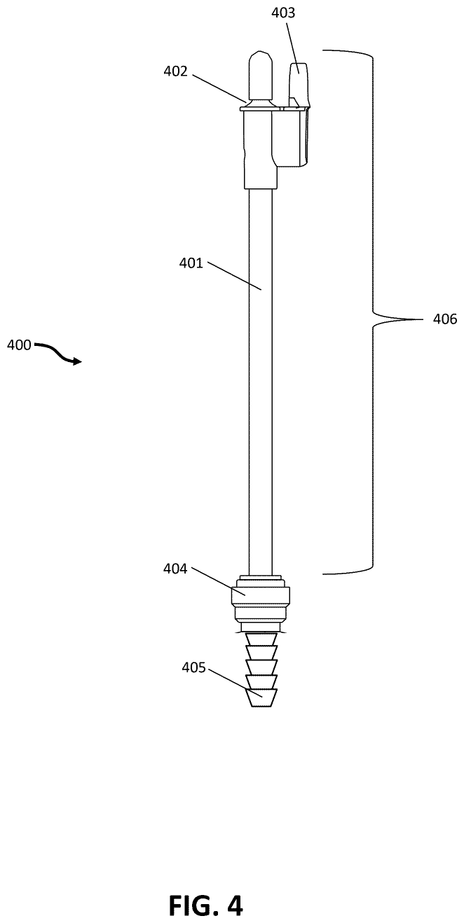

FIG. 3 shows an external view of CPT 300 having hollow fiber membrane filters with transport caps removed and shown next to the CPT, according to an exemplary embodiment of the present subject disclosure. CPT 300 comprises a filter housing 301, an elution fluid or retentate port 302, a permeate port 303, and a sample port 304. Next to CPT 300 are three transport caps, an elution or retentate port cap 305, a permeate port cap 306, and a sample port cap 307. FIG. 4 shows an external view of CPT sampling assembly 400 having a CPT 406 with hollow fiber membrane filters attached to a push-to-connect type fitting 404 with a hose barb 405 attached to the CPT 406 sample port, according to an exemplary embodiment of the present subject disclosure. CPT sampling assembly 400 comprises a CPT 406 filter housing 401, a CPT 406 elution fluid or retentate port 402, a CPT permeate port 403, and a CPT 406 sample port (hidden from view). This configuration allows for connection of a length of tubing to the sample port (hidden from view) that can be connected to a pump, water line, pressure regulator, syringe, or other device for delivering a sample to the sample port of CPT sampling assembly 400, under positive pressure. A prefilter can be added as necessary within this assembly to provide for removal of non-target materials. This configuration allows for sampling onto the hollow fiber membrane filters within CPT 406 in a remote, field location, or any location outside of the laboratory, then the sample can be sealed and transported to the laboratory for elution and analysis.

Push-to-connect type fittings like push-to-connect fitting 404 may alternatively be referred to as “Push-to-Connect”, “Push to Connect”, “Push-Lok”, “Push On”, “Push-On”, “Push-In”, “Push-Fit”, “John Guest”, or a range of other names that will be well known to those skilled in the art. These fittings may be in a 5/16″ size, which would allow for direct insertion of filter housing 401 of CPT 406 for a leak-free connection. Other methods of direct leak-free connection to the outside of filter housing 401 at the sample port including sliding a length of flexible tubing over filter housing 401, integrating threads into filter housing 401, bonding a Luer lock fitting to filter housing 401 and connecting a Luer lock adapted length of tubing, or many other methods will be well known to those skilled in the art.

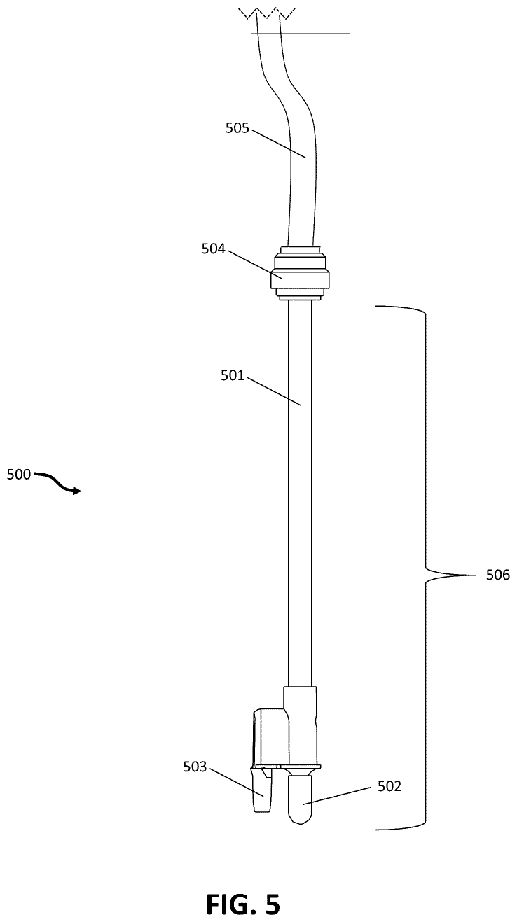

FIG. 5 shows an external view of CPT sampling assembly 500 with CPT 506 with hollow fiber membrane filters with a push-to-connect type fitting 504 and length of flexible tubing 505 attached to the CPT sample port, according to an exemplary embodiment of the present subject disclosure. CPT 506 comprises a filter housing 501, an elution fluid or retentate port, which is hidden from view by elution fluid or retentate port cap 502, a permeate port 503, and a sample port, which is hidden from view by push-to-connect type fitting 504. This configuration allows for connection of a pump, water line, pressure regulator, syringe, or other device for delivering a sample to the sample port of CPT 506, using positive pressure. A standard CPT 506 will have a check valve within the elution fluid or retentate port, that only allows for flow into the retentate through the elution fluid or retentate port and not in the reverse direction, so keeping elution fluid or retentate port cap 502 in place during sampling is not necessary, but may be used, as shown, to ensure that no liquid comes out of the elution fluid or retentate port or it may be used if CPT 506 does not contain a check valve within the elution fluid or retentate port.

Permeate port 503 is left open to allow filtered sample to drain from CPT 506 during sampling. Pressurized sample is provided to tubing 505 from a pump or other device and travels through the internal hollow fiber membrane filters where target particles are retained within the retentate. A prefilter may be used in between two sections of tubing or between tubing 505 and pump or between tubing 505 and CPT 506, for removal of non-target materials, as will be well understood by those skilled in the art. The filtered fluid then flows out of permeate port 503. A sample container with a volume mark, graduated cylinder, or a sample container on a balance may be used to determine when a set volume has been processed or the volume processed may be gauged to be complete when all sample has been drawn out of a container by the pump and has entered CPT 506.

This allows for sampling onto the hollow fiber membrane filters within CPT 506 in a remote, field location, or any location outside of the laboratory, then the sample can be sealed and transported to the laboratory for elution and analysis.

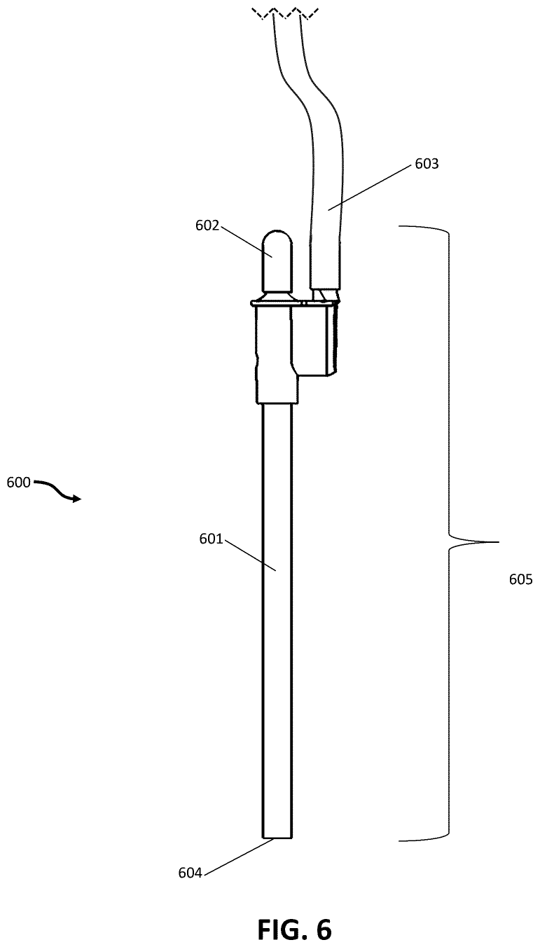

FIG. 6 shows an external view of a CPT sampling assembly 600 with CPT 605 with hollow fiber membrane filters with a length of flexible tubing 603 attached to permeate port (hidden from view by tubing 603), according to an exemplary embodiment of the present subject disclosure. CPT 605 comprises a filter housing 601, an elution fluid or retentate port, which is hidden from view by elution fluid or retentate port cap 602, a permeate port, which is hidden from view by length of tubing 603, and a sample port 604. This configuration allows for connection of a pump, syringe, vacuum bottle or chamber, or other device for pulling negative pressure on length of tubing 603 and drawing a sample into sample port 604 and through internal hollow fiber membrane filters within CPT 605, using a suction to draw the sample into sample port 604. A prefilter may also be attached directly to sample port 604 or to a section of tubing attached to port 604 for removal of non-target materials, as will be well understood by those skilled in the art. The filtered sample is then drawn out through the permeate port and tubing 603. A standard CPT 605 will have a check valve within the elution fluid or retentate port, but the check valve allows flow to enter the retentate chamber through the elution fluid or retentate port, so elution fluid or retentate port cap 602 is used during sampling in this configuration to not allow air to leak in through this port.

After dipping sample port 604 into a sample and initiating the negative pressure source sample is aspirated into CPT 605 through sample port 604 and travels into the internal retentate chamber and through the internal hollow fiber membrane filters where target particles are retained within the retentate. The filtered fluid then flows out of the permeate port and length of tubing 603 and pump, or into the vacuum bottle or other negative pressure reservoir. A sample container with a volume mark, graduated cylinder, or a sample container on a balance may be used downstream of the pump or a graduated vacuum bottle may be used to determine when a set volume has been processed or the volume processed may be gauged to be complete when all sample has been drawn out of a sample container by sample port 604. Further, the hollow fiber membrane filters within CPT 605 will lock-up when air is drawn into them, so generally the user will look for a stoppage of flow coming out of the pump or an increase in negative pressure on the permeate side or a flow meter may be used to determine when no flow is present.

This configuration allows for sampling onto the hollow fiber membrane filters within CPT 605 in a remote, field location, or any location outside of the laboratory, then the sample can be sealed and transported to the laboratory for elution and analysis. Further, this configuration has the distinct advantage when being used with a pump of the sample contacting nothing in the system other than CPT 605, which significantly reduces the chance of cross contamination of the sample and reduces consumable components and the need to clean components between samples being processed.

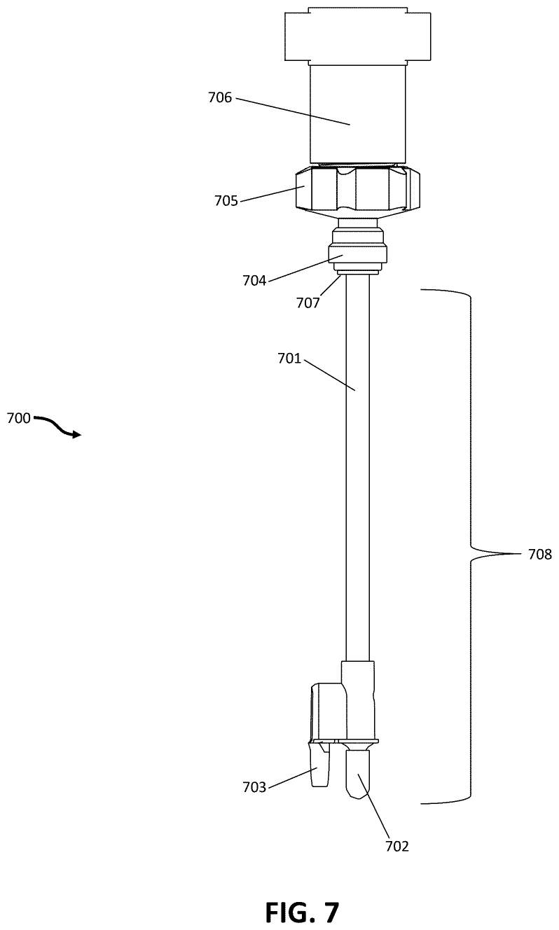

FIG. 7 shows an external view of CPT sampling assembly 700 with CPT 708 with hollow fiber membrane filters with push-to-connect type fitting 704 and a preset water pressure regulator 706 attached to the sample port, which is hidden by push-to-connect fitting 704, according to an exemplary embodiment of the present subject disclosure. CPT 708 comprises a filter housing 701, an elution fluid or retentate port, which is hidden from view by elution fluid or retentate port cap 702, a permeate port 703, and a sample port, which is hidden from view by push-to-connect type fitting 704. The described configuration allows for preset water pressure regulator 706 to be connected to, for example, a standard ¾″ garden hose thread as would normally be found on a water spigot. The push pull fitting is then attached to the regulator to allow the user to easily, directly connect the CPT to the water line for water system sampling. Alternatively, this approach may be attached to non-standard water systems, such as in a water treatment plant, a water reuse plant, or on spigots attached to systems such as cooling tower water reservoirs, swimming pools, water park reservoirs, wash water reservoirs in food packaging or manufacturing facilities, wastewater systems, fuel tanks or distribution systems, or a range of other systems where water or other liquids are held under a head pressure.

A range of preset water pressure regulators are readily available with a variety of thread sizes on the input side and on the output side and a range of preset output pressures. In the United States, for instance, water line pressures range from 45 to 80 psi and while the lower end of this range may be acceptable for direct connection to CPT 708, the upper end is likely to be high enough to rupture or otherwise damage the hollow fiber membrane filters within CPT 708. For this reason, a preset or settable water pressure regulator, or other means of reducing the water pressure is often necessary. Alternatively, to a standard water pressure regulator a fitting containing a plate with an orifice or multiple orifices, a check valve which adds pressure drop and thereby reduces the flow rate through the system, a valve, or other means of reducing the flow rate or pressure may be used, as will be understood by those skilled in the art.

In the case of reducing the flow rate, rather than regulating the pressure, an orifice or other constriction, such as a valve, must be set such that at the highest pressure that can be delivered from the sampled system the constriction will only allow a flow rate through that can be accepted by CPT 708 without exceeding the upper pressure limit of the CPT 708. As an example, in the case of Applicant InnovaPrep's current 0.2 μm hollow fiber membrane filter CPT, a nominal maximum transmembrane pressure of 50 psi should not be exceeded. At this pressure this CPT will allow a nominal flow rate of 1 L/min. Based on this information, an orifice should be selected that will allow a maximum of 1 L/min at the maximum unregulated water line pressure. Assuming that the maximum waterline pressure is 80 psi then an orifice that allows a maximum of 1 L/min at 80 psi would be used. Further, generally a safety factor should also be applied to ensure that fouling of the CPT membrane does not result in slowing flow rate and the maximum desired pressure being exceeded. In this case of this scenario a 2× safety factor may be selected-meaning that an orifice allowing only 500 mL/min at 80 psi head pressure would be selected. The orifice size may be selected by calculating the required orifice size or by lookup table or through empirical trials, as would be well known by those skilled in the art.

In addition to pressure regulator or flow constrictor a check valve may be used to ensure that a reverse flow into the water system is not possible. This is a standard safety feature when attaching external systems to a waterline.

In a standard use case for the described configuration, the preset regulator 706 is threaded onto a water spigot. Push-to-connect connector 704 is then attached to regulator 706 using threaded connector 705. An example push-to-connect fitting for use in this system is the DMFit brand female garden hose adapter with 5/16″ Push-in×¾″ NH flat inside. An example of regulator 706 is Camco Camper/RV Water Hose Pressure Regulator. Alternatively to attaching these each time that a sample is taken, they may be left in place for routine daily or weekly sample collection. Further, a prefilter may be into the regulator or orifice assembly or attached to either, for removal of non-target materials, as will be well understood by those skilled in the art.

If caps are in place on CPT 708, the cap over permeate port 703 and the sample port are both removed, while elution fluid or retentate port cap 702 is left in place. Filter housing 701 of CPT 708 is then pushed into push-to-connect connector 704 such that a watertight connection is achieved. Of note, the elution fluid or retentate port on CPT 708, in its standard commercial configuration, contains a check valve which allows flow in through this port but does not allow flow out of this port. For this reason, leaving elution fluid or retentate port cap 702 in place is not necessary, but may be used as a safeguard of leakage or contamination of this port.

After connection of CPT 708 to push-to-connect 704, a container may be placed under permeate port 703 to catch the filtered sample. A graduated cylinder or a container with a desired sample volume mark may be used to allow the user to close the valve when the desired volume has been reached. Alternatively, the container may be placed on a balance and the balance may be tared prior to sampling to allow for a set end mass to be reached before sampling is stopped. A length of flexible tubing may also be attached to permeate port 703 to allow the filtered sample to be routed to a container or drain. The valve on the waterline or spigot can then be slowly opened to reduce the potential for a rapid surge of water through CPT 708.

After the water flow through CPT 708 is initiated, the user will monitor the system until the desired volume has been filtered. Once the desired volume has been filtered the user will then slowly close the valve on the water line. The user then waits until all water has stopped flowing from permeate port 703 and then places the transport cap over permeate port 703, as well as over the elution fluid or retentate port, if cap 702 is not already in place. The user then pushes against release ring 707 of push-to-connect fitting 704 and slowly removes filter housing 701 of CPT 708. CPT 708 is then held vertically with the uncapped sample port at the top to reduce the potential for any drips coming from the sample port. The user then places a transport cap over the sample port of CPT 708.

CPT 700 is then placed into a transport container and taken to a laboratory for elution and analysis, or it is placed into a cold shipment container on wet ice and shipped to the laboratory. When CPT 708 is received by the laboratory the analyst will first make sure that the Concentrating Pipette instrument is ready to perform the elution process. Using standard Concentrating Pipette procedures, as outlined in the user manual, the analyst will perform an instrument startup and ensure that the elution fluid and instrument settings are appropriate for the CPT being used and are compatible with the target particles and the downstream processing and analysis steps.

CPT 708 is then removed from the packaging. While holding CPT 708 vertically with the elution fluid or retentate port and the permeate port at the top, the cap over elution fluid or retentate port 703 and the permeate port cap 702 are then removed. While still holding CPT 708 vertically, with the elution fluid or retentate port 703 and the permeate port at the top, the elution fluid or retentate port 703 and the permeate port are inserted into the Concentrating Pipette instrument head manifold ports.

With CPT 708 inserted into the head manifold and with the permeate port cap still in place, a sample processing run is then initiated on the Concentrating Pipette instrument by the user through the instrument's user interface. This helps to draw fluid remaining in the bottom portion of CPT 708 and within the permeate port cap into CPT 708, reducing drips that may come from CPT 708. The onboard flow sensor within the Concentrating Pipette instrument will shut down the sample processing run within approximately 20 seconds due to no flow through CPT 708. Once the sample processing run stops the user is asked whether they would like to elute the sample or perform a wash step.

The simplest approach is to perform an immediate elution by selecting the elution choice and then following the steps that the instrument user interface describes. The user then holds a sample container under the sample port of CPT 708 and the sample eluate is dispensed into the container. The analyst then proceeds with downstream processing, extraction, and analysis steps.

Alternatively, a wash step may be performed. Use of a wash step, prior to elution, was demonstrated to improve recovery of target bacteria when compared to elution without a wash step being performed first. When the wash step is initiated through the Concentrating Pipette instrument user interface the user interface then takes the user through a series of steps with the user placing a wash fluid under CPT 708 and lowering the manifold head such that the sample port is dipped into the wash fluid. The instrument then injections fluid into CPT 708 to allow for restart of the membrane filter flow and the wash fluid is then aspirated into CPT 708 and flow through the hollow fiber membrane filters out permeate port 703 and through the instrument. When the entire wash fluid volume has been processed the instrument alerts the user and the user selects to elute the sample and follows the normal elution process. The analyst may then continue with standard processing, extraction, and analysis.

Wash fluids can range from 3 mL to 500 mL or more in volume or more, preferably from 10 mL to 250 mL, or most preferably from 25 mL to 100 mL. Wash fluids are generally standard buffers such as PBS or Tris buffered water with surfactant, detergent or dispersant added to improve recovery of target particles from the membrane filters. Chelators may also be added and the pH adjusted to improve removal of non-target materials such as natural organic matter and humics. One specific recommended wash fluid is 25 mM Tris with 1 mM EDTA with 0.1% Tween 20. This fluid acts to solubilize humic substances and to improve recover of target particles.

The wash step can include a manually performed incubation period whereby the wash fluid is left in the lumen of the hollow fiber membrane filters for a period of time ranging from 1 second to 60 minutes. More specifically, incubation periods will range from 1 second to 1 minute in length. This is simply performed by pausing the instrument wash step for a period of time and then restarting it using the user interface. Repeated wash steps can also be performed using the procedure described. One more fluid types can be used for wash steps in this way.

Wash fluids can include any number of fluid types that will help wash away soluble materials and small particles that may be co-concentrated onto the hollow fiber membrane filters along with the target materials. In general the wash fluids are meant to solubilize and dissociate these non-target materials without damaging or significant affecting the target materials. Fluids and chemical solutions capable of performing these actions will be well known to those skilled in the art. The wash fluids may include surfactant solutions, ionic solutions, ionic liquids, coagulants, buffer solutions, chelators, higher or low pH solutions, solvent solutions, or a range of other solutions may be used. This list of possible solutions is not anticipated to be all encompassing and many other solution types could be used as will be understood by one skilled in the art. The reasons for performing a wash step include, but are not limited to: causing changes to interactions between target viral, bacterial or other particles and non-target particles present in the sample; solubilizing or washing away of natural organic matter, including humic and fulvic substances, proteins, polysaccharides, and other non-target particles and molecules; improving recovery of target particles by flushing the captured particles with Tween 20, Tween 80, sodium polyphosphate, glycine or other surfactants, proteins, chemical dispersants, or other chemicals that are known to improving recovery of target particles from membrane filters; and simply improving the buffer exchange process performed on the membrane filter by allowing residual liquid on the membrane to be washed away to the permeate.

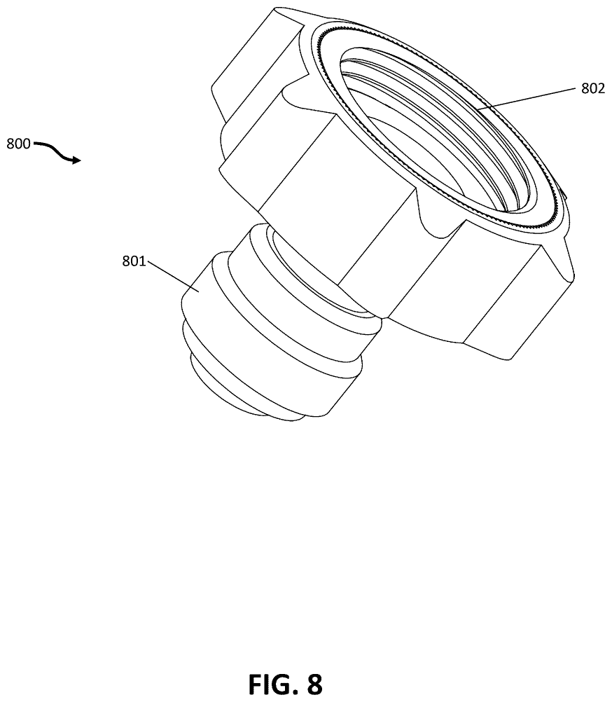

FIG. 8 shows push-to-connect type fitting 800 with a push-to-connect mechanism 801 and garden hose threaded or NPT threaded connector 802, according to an exemplary embodiment of the present subject disclosure. This is a more detailed drawing of the fitting used in FIG. 7.

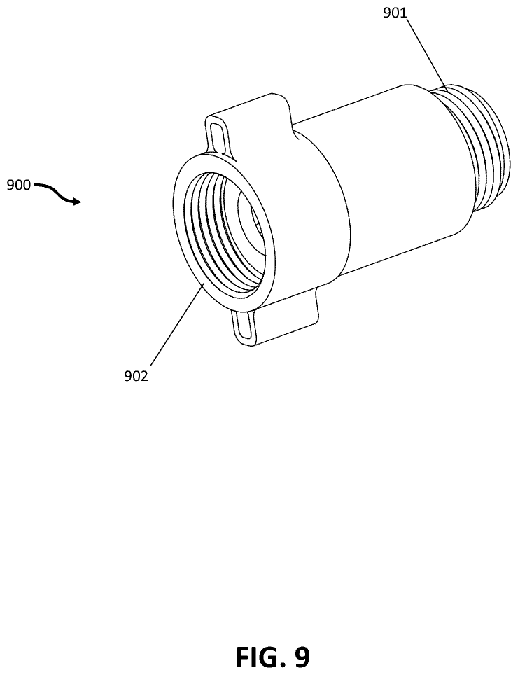

FIG. 9 shows a preset water pressure regulator 900, according to an exemplary embodiment of the present subject disclosure. Preset water pressure regulator 900 contains threaded inlet 902 and threaded outlet 901. Threaded inlet 902 is threaded onto a water spigot or valve and threaded outlet is threaded onto a push-to-connect fitting or other fitting to attach to a CPT. An example of regulator 900 is Camco Camper/RV Water Hose Pressure Regulator. A range of preset water pressure regulators are readily available with a variety of thread sizes on the input side and on the output side and a range of preset output pressures. In the United States, for instance, water line pressures range from 45 to 80 psi and while the lower end of this range may be acceptable for direct connection to the CPT, the upper end is likely to be high enough to rupture or otherwise damage the hollow fiber membrane filters within the CPT. For this reason, a preset or settable water pressure regulator, or other means of reducing the water pressure is often necessary. Alternatively, to a standard water pressure regulator a fitting containing a plate with an orifice or multiple orifices, a check valve which adds pressure drop and thereby reduces the flow rate through the system, a valve, or other means of reducing the flow rate or pressure may be used, as will be understood by those skilled in the art.

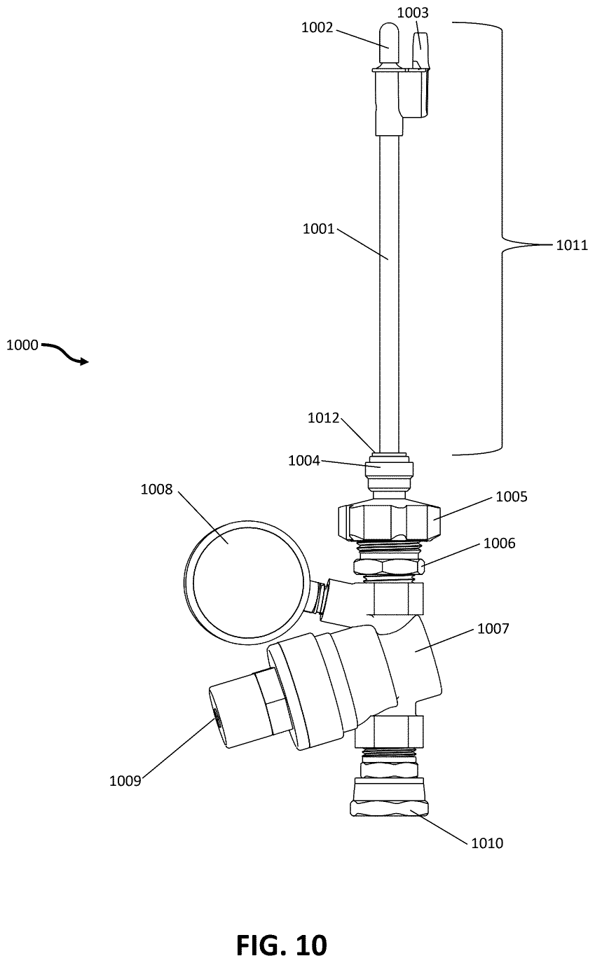

FIG. 10 shows an external view of CPT sampling assembly 1000 with CPT 1011 having hollow fiber membrane filters with a push-to-connect type fitting 1004 and an adjustable water pressure regulator 1007 attached to the CPT sample port, which is hidden from view by push-to-connect type fitting 1004, according to an exemplary embodiment of the present subject disclosure. This embodiment allows for direct connection of CPT 1011 to the water line for water system sampling. Further, a prefilter may be into the regulator or orifice assembly or attached to either, for removal of non-target materials, as will be well understood by those skilled in the art. This approach may also be by attachment to non-standard water systems, such as in a water treatment plant, a water reuse plant, or on spigots attached to systems such as cooling tower water reservoirs, swimming pools, water park reservoirs, wash water reservoirs in food packaging or manufacturing facilities, wastewater systems, fuel tanks or distribution systems, or a range of other systems where water or other liquids are held under a head pressure.

CPT 1011 comprises a filter housing 1001, an elution fluid or retentate port, which is hidden from view by elution fluid or retentate port cap 1002, a permeate port 1003, and a sample port, which is hidden from view by push-to-connect type fitting 1004. The described configuration allows for adjustable water pressure regulator 1007 to be connected to, for example, a standard ¾″ garden hose thread using inlet fitting 1010. Push-to-connect fitting 1004 is then attached to the outlet of adjustable water pressure regulator 1007 using adapter 1005 and male-to-male coupler 1006. Many possible configurations for providing an adjustable water pressure regulator and connector for attaching CPT 1011 can assembled as will be understood by those skilled in the art.

After assembling the adjustable water pressure regulator 1007 and fittings the water valve may be slowly opened to flush water through the system. The valve is then closed and a plug may be placed into push-to-connect fitting 1004. The valve is then reopened and the outlet water pressure can then be adjusted using adjustment screw 1009 while reading the pressure on gauge 1008. The valve is then closed and the plug is removed from push-to-connect fitting 1004. CPT 1011 is then inserted into push-to-connect fitting 1004 a container may be placed under permeate port 1003 to catch the filtered sample. A graduated cylinder or a container with a desired sample volume mark may be used to allow the user to close the valve when the desired volume has been reached. Alternatively, the container may be placed on a balance and the balance may be tared prior to sampling to allow for a set end mass to be reached before sampling is stopped. A length of flexible tubing may also be attached to permeate port 1003 to allow the filtered sample to be routed to a container or drain. The valve on the waterline or spigot can then be slowly opened to reduce the potential for a rapid surge of water through CPT 1011.

After the water flow through CPT 1011 is initiated, the user will monitor the system until the desired volume has been filtered. Once the desired volume has been filtered the user will then slowly close the valve on the water line. The user then waits until all water has stopped flowing from permeate port 1003 and then places the transport cap over permeate port 1003, as well as over the elution fluid or retentate port, if cap 1002 is not already in place. The user then pushes against release ring 1012 of push-to-connect fitting 1004 and slowly removes filter housing 1001 of CPT 1011. CPT 1011 is then held vertically with the uncapped sample port at the top to reduce the potential for any drips coming from the sample port. The user then places a transport cap over the sample port of CPT 1011.

CPT 1011 is then placed into a transport container and taken to a laboratory for elution and analysis, or it is placed into a cold shipment container on wet ice and shipped to the laboratory. When CPT 1011 is received by the laboratory the analyst will first make sure that the Concentrating Pipette instrument is ready to perform the elution process. Using standard Concentrating Pipette procedures, as outlined in the user manual, the analyst will perform an instrument startup and ensure that the elution fluid and instrument settings are appropriate for the CPT being used and are compatible with the target particles and the downstream processing and analysis steps.

CPT 1011 is then removed from the packaging. While holding CPT 1011 vertically with the elution fluid or retentate port and the permeate port at the top, the cap over elution fluid or retentate port 1002 and the permeate port cap 1003 are then removed. While still holding CPT 1011 vertically, with the elution fluid or retentate port 1003 and the permeate port at the top, the elution fluid or retentate port 1002 and the permeate port are inserted into the Concentrating Pipette instrument head manifold ports.

With CPT 1011 inserted into the head manifold and with the permeate port cap still in place, a sample processing run is then initiated on the Concentrating Pipette instrument by the user through the instruments user interface. This helps to draw fluid remaining in the bottom portion of CPT 1011 and within the permeate port cap into CPT 1011, reducing drips that may come from CPT 1011. The onboard flow sensor within the Concentrating Pipette instrument will shut down the sample processing run within approximately 20 seconds due to no flow through CPT 1011. Once the sample processing run stops the user is asked whether they would like to elute the sample or perform a wash step.

The simplest approach is to perform an immediate elution by selecting the elution choice and then following the steps that the instrument user interface describes. The user then holds a sample container under the sample port of CPT 1011 and the sample eluate is dispensed into the container. The analyst then proceeds with downstream processing, extraction, and analysis steps.

Alternatively, a wash step may be performed. Use of a wash step, prior to elution, was demonstrated to improve recovery of target bacteria when compared to elution without a wash step being performed first. When the wash step is initiated through the Concentrating Pipette instrument user interface the user interface then takes the user through a series of steps with the user placing a wash fluid under CPT 1011 and lowering the manifold head such that the sample port is dipped into the wash fluid. The instrument then injection fluid into CPT 1011 to allow for restart of the membrane filter flow and the wash fluid is then aspirated into CPT 1011 and flow through the hollow fiber membrane filters out permeate port 1003 and through the instrument. When the entire wash fluid volume has been processed the instrument alerts the user and the user selects to elute the sample and follows the normal elution process. The analyst may then continue with standard processing, extraction, and analysis.

Wash fluids can range from 3 mL to 500 mL or more in volume or more preferably from 10 mL to 250 mL or most preferably from 25 mL to 100 mL. Wash fluids are generally standard buffers such as PBS or Tris buffered water with surfactant, detergent or dispersant added to improve recovery of target particles from the membrane filters. Chelators may also be added and the pH adjusted to improve removal of non-target materials such as natural organic matter and humics. One specific recommended wash fluid is 25 mM Tris with 1 mM EDTA with 0.1% Tween 20. This fluid acts to solubilize humic substances and to improve recover of target particles.

The wash step can include a manually performed incubation period whereby the wash fluid is left in the lumen of the hollow fiber membrane filters for a period of time ranging from 1 second to 60 minutes. More specifically, incubation periods will range from 1 second to 1 minute in length. This is simply performed by pausing the instrument wash step for a period of time and then restarting it using the user interface. Repeated wash steps can also be performed using the procedure described. One more fluid types can be used for wash steps in this way.

Wash fluids can include any number of fluid types that will help wash away soluble materials and small particles that may be co-concentrated onto the hollow fiber membrane filters along with the target materials. In general the wash fluids are meant to solubilize and dissociate these non-target materials without damaging or significantly affecting the target materials. Fluids and chemical solutions capable of performing these actions will be well known to those skilled in the art. The wash fluids may include surfactant solutions, ionic solutions, ionic liquids, coagulants, buffer solutions, chelators, higher or low pH solutions, solvent solutions, or a range of other solutions may be used. This list of possible solutions is not anticipated to be all encompassing and many other solution types could be used as will be understood by one skilled in the art. The reasons for performing a wash step include, but are not limited to: causing changes to interactions between target viral, bacterial or other particles and non-target particles present in the sample; solubilizing or washing away of natural organic matter, including humic and fulvic substances, proteins, polysaccharides, and other non-target particles and molecules; improving recovery of target particles by flushing the captured particles with Tween 20, Tween 80, sodium polyphosphate, glycine or other surfactants, proteins, chemical dispersants, or other chemicals that are known to improving recovery of target particles from membrane filters; and simply improving the buffer exchange process performed on the membrane filter by allowing residual liquid on the membrane to be washed away to the permeate.

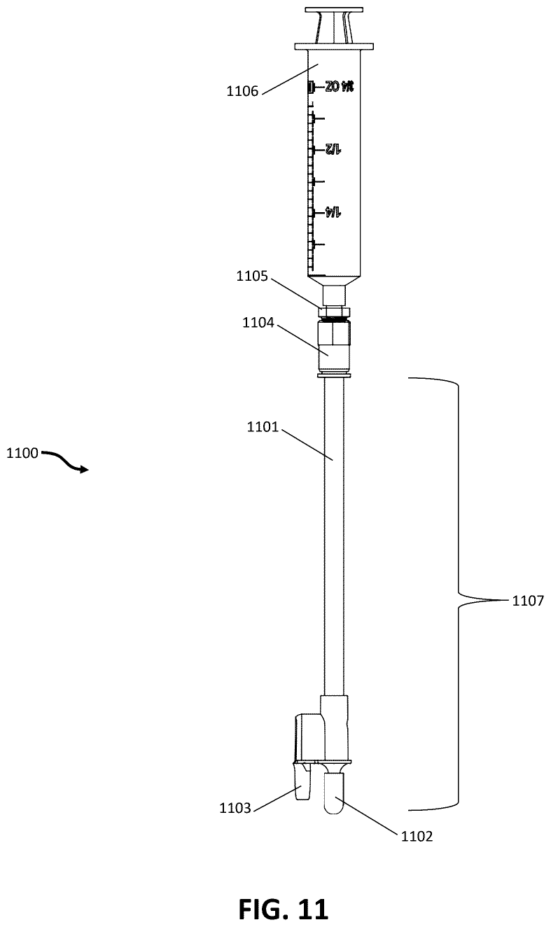

FIG. 11 shows an external view of a sample storage system 1100 for filling CPT 1107, having hollow fiber membrane filters, with a transport buffer using a push-to-connect type fitting 1104 and transport buffer syringe 1106 attached to the CPT sample port, hidden from view by push-to-connect type fitting 1104, according to an exemplary embodiment of the present subject disclosure. Alternatively, to push-to-connect type fitting 1104, a slip fit connection made of a soft plastic or rubber compound may be used, in order to reduce the cost of this component, or other connection mechanisms such as a luer-lock fitting or threaded fitting may be used, as will be well understood by those skilled in the art. This embodiment can be generally used after sampling onto CPT 1107 in a remote or field location where transport or shipment of the sample to a laboratory is required.

The described embodiment can be used to help maintain sample quality after sampling onto CPT 1107, such as when using one of the described embodiments in FIG. 4, FIG. 5, FIG. 6, FIG. 7, or FIG. 10 to sample from a water source, water line, or other liquid sample type. Syringe 1106, which has been filled with transport buffer, is used along with a push-to-connect fitting 1104 and Luer lock fitting 1105 to connect to CPT 1107. A manual procedure is then used to push a transport buffer into the retentate and permeate of CPT 1107.

Syringe 1106 may be sold or provided to the end user as a prefilled syringe or may be filled by the user from a bottle. The transport buffer can be selected from a range of buffers known or designed to stabilize samples, lyse target and stabilize DNA or RNA, and inhibit growth during transport and short-term storage. Alternatively, a selective media meant to enhance growth of one or more microorganisms can be used to inhibit growth of competing organisms and initiate growth of target organisms. The transport or storage may be performed on dry ice, wet ice, in refrigerated conditions, at room temperature or even at elevated temperatures to initiate growth of certain microorganisms. The storage and transport temperature requirements and transport time are determined based on the transport buffer characteristics and needs. Transport buffers that may be used including, but not limited to, ethanol, methanol, viral transport media, protein transport media, selective growth media, PBS, growth media, and may include protein, buffers, surfactants and other additives to enhance stability, which will be well known to those skilled in the art. Further, commercially available stabilization buffers, such as DNA/RNA Shield, PrepProtect Stabilization Buffer, RNAprotect, or a range of other commercially available stabilization fluids which will be well known to those skilled in the art.

In general, storage and transport media can be split into lytic viral transport media, lytic bacterial transport media, and non-lytic transport media. Each may be advantageous due to the target organisms, work flow requirements, transport and storage requirements, and analysis techniques.

Non-lytic viral transport media typically contain antibiotics and antifungals to suppress growth, can be used for multiple viral diagnostic applications. Some Non-lytic viral transport media include: UTM (Copan)—viral transport; VTM (Hardy Diag.)—viral transport, maintains culturability; UVT (universal viral transport system, BD)—viral transport, similar to VTM; and other commercially available and custom formulations, as will be well known by those skilled in the art.

Non-lytic bacterial transport media can be selective or non-selective, typically based on buffered salts along with other additives. In some cases, the medium promotes growth and preserves specific bacterial types. Some well know formulations include, Cary-Blair, for enteric pathogens; Amies medium, for various pathogens; Alkaline or buffered peptone water, for a variety of bacteria; Glycerol-based media, useful for organisms that can metabolize glycerol; and Lim broth, for Streptococci. Additionally, a range of antibiotic and other selective media, for isolating specific targets (e.g., MRSA, etc.), such as Selenite broth and Anaerobic transport medium.

Lytic/deactivating media, which are used for preserving DNA and RNA during ambient transport and storage, for up to 30 days, deactivate pathogens, by lysis or killing, to render them non-infective. Some examples of lytic/deactivating media include: DNA/RNA shield; guanidine-based (aka Molecular Transport Medium, MTM); PrimeStore (Longhorn); and InhibiSure (ThermoFischer), and other commercial and customer formulations that will be well known to those skilled in the art. Many of these products are guanidine-based, but some newer products use formulations that are deemed to be safer.

Non-lytic and lytic transport media, in general, can be used with the sample storage system 1100, to improve the stability of collected samples and in some cases to be transported or shipped at room temperature. In general samples stored using this method, with non-lytic transport media, can be later eluted by tangential retentate elution with wet foam or a liquid buffer because the media can be selected to ensure that the majority of the target microorganisms remain intact and there are retained within the retentate. Conversely, lytic transport media, will cause lysis and therefor the nucleic acids from target microorganisms will likely be found in the transport media contained both within the retentate and the permeate. For this reason, samples that are transport with lytic transport media will be required to pull the entire retentate and permeate volume to recovery a high percentage of the target nucleic acids.

The method of injection the transport buffer is somewhat dependent on the method of collection onto CPT 1107. When sampling under positive pressure as is shown in FIG. 4, FIG. 5, FIG. 7, and FIG. 10, there are several methods of transport buffer injection that will be described. The first method works for water line sampling as is shown in FIG. 7, and FIG. 10 and also works for FIG. 4 and FIG. 5, if the sample pump is stopped while sample is still present in the sample reservoir or pump inlet hose. In this case, after shutting off the pump, fluid in CPT 1107 is allowed to drain through permeate port 1103 until no additional fluid drains out, before proceeding to remove the CPT from the water line or pump and inject the transport buffer. Further, the same method, as described below, also works for samples collected using the configuration disclosed in FIG. 6, if the sample pump is stopped while the sample port of the CPT 1107 remains in the sample until the sample pump is turned off and for a short wait period of a few seconds after that time. In each of these cases CPT 1107 remains full of sample and the required volume of transport media can simply be pushed into the CPT with the syringe.

More specifically, after sampling is complete a cap is either placed over permeate port 1103 or CPT 1107 is held horizontally to inhibit loss of liquid from permeate port 1103. At this time CPT 1107 can be disconnected from the connected pump and tubing. Syringe 1106, containing a volume of transport buffer is then connected to Luer lock fitting 1105 and push-to-connect fitting 1104. This assembly is then pushed onto filter housing 1101 of CPT 1107. If present, the cap over permeate port 1103 is removed and the plunger of syringe 1106 is pushed into until all transport buffer is pushed into CPT 1107. Syringe 1106 is then removed from CPT 1107 and caps are then placed onto each port of CPT 1107 and it is placed into a sample transport container and transported to laboratory for subsequent sample removal, processing, extraction, and analysis.

Of note, for the configuration disclosed in FIG. 6, the transport buffer can also be injected into CPT 1107 by attaching the syringe 1106 to filter housing 1101 while CPT 1107 is still full of sample fluid and is still attached to the sample pump tubing. The sample pump can then be turned back on and syringe 1106 plunger is drawn down by the pump suction until the transport buffer fully fills CPT 1107. If necessary the user may also depress syringe 1106 plunger while the pump runs. Syringe 1106 may then be removed, and replaced by a cap, and CPT 1107 may be removed from the sample pump and a cap may be placed over permeate port 1103 before packaging for transport.

In some cases it may be necessary to draw or push air into CPT 1107 at the end of the sample processing. In these cases, the membrane filter will lock up which causes injection of the transport fluid to be more difficult. The following procedures described are used for injection transport fluid in these cases. First, after removing CPT 1107 from the sampling assembly, retentate port cap 1102 is placed over the retentate port, if not already in place. The user may then inject the transport fluid by using an oversized syringe 1106 that is only approximately 5% to 50% full with transport fluid or more precisely 10% to 40% full. The syringe 1106 assembly and fittings are attached to filter housing 1101 and the plunger of syringe 1106 is then drawn back to pull a vacuum on retentate chamber within CPT 1107. The full assembly is then held vertically with the syringe at top and the fluid is injected into CPT 1107 by depressing the plunger of syringe 1106. This approach works because the vacuum void can now be filled with fluid and the fluid can even be pushed through the membrane filter wall. Using this method CPT 1107 can be partially filled with transport buffer, if the permeate port cap is in place or more transport buffer may be injected until a portion flows out of the permeate port 1103, if desired.

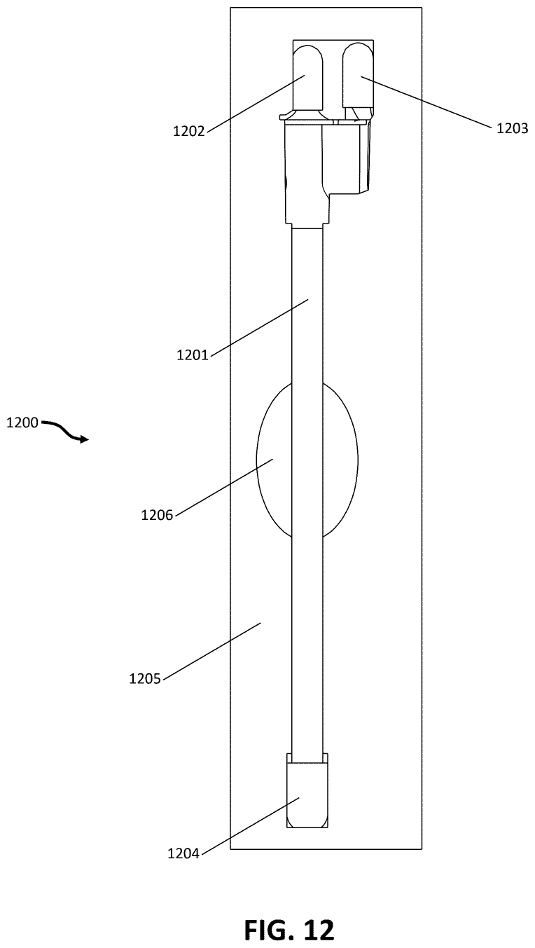

FIG. 12 shows an external view of shipping assembly 1200 for CPT 1201 having hollow fiber membrane filters with transport caps in place and placed into foam packaging insert 1205, according to an exemplary embodiment of the present subject disclosure. Foam packaging insert 1205 provides a small, low-cost protective enclosure for transport or shipping of CPT 1201 to a laboratory for subsequent elution, processing, extraction, and analysis. Cutaway 1206 allows for CPT 1201 to be easily grasped for removal. In place over CPT 1201 ports are three transport caps, an elution or retentate port cap 1202, a permeate port cap 1203, and a sample port cap 1204. The caps can be placed over the three ports when shipping CPTs to customers for use or when shipping back from the customer after sampling. The caps can also be used for closing off one or more ports while processing samples.

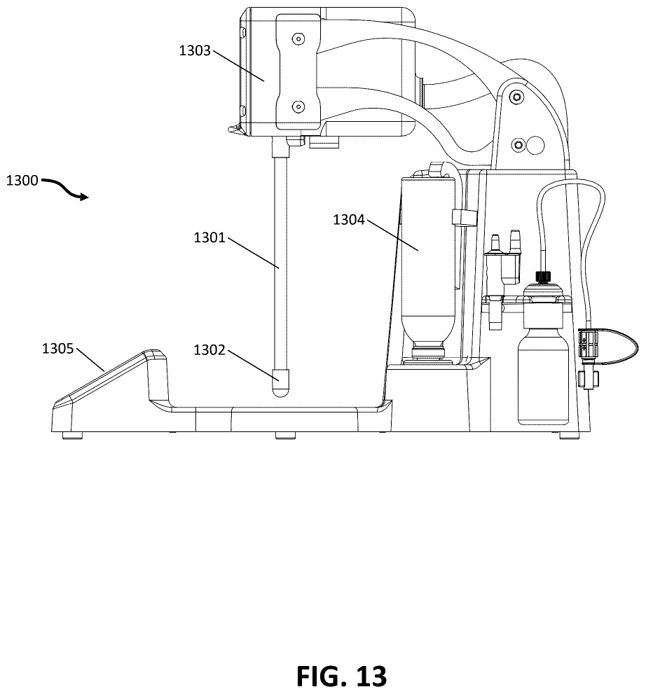

FIG. 13 shows Concentrating Pipette instrument 1300 with CPT 1301 having hollow fiber membrane filters with a transport cap on the CPT sample port, according to an exemplary embodiment of the present subject disclosure. The Concentrating Pipette instrument can be used to elute concentrated samples from CPT 1301 after remote or field collection using the configurations disclosed in FIG. 4, FIG. 5, FIG. 6, FIG. 7, and FIG. 10.

Using standard procedures outlined in the user manual and quick start guide for the commercially available Concentrating Pipette instrument 1300 the instrument is set up and a daily startup procedure is performed to prepare the instrument for sample elution. Standard instrument setpoints can be used or can be customized for specific applications. CPT 1301 is then held vertically with the sample port and sample port cap 1302 in the down position. The elution port cap or retentate port cap (such as 1202 in FIG. 12) and permeate port cap (such as 1203 in FIG. 12) are then removed and CPT 1301 is then inserted into the CPT port in manifold head 1303. Using user interface 1305 the user then initiates a sample processing run, but leaves sample port cap 1302 in place and does not place a sample under the CPT. The instrument will then stop the run within approximately 20 seconds due to a lack of flow. When the instrument stops the user can then remove sample port cap 1302 and may place a wash fluid under CPT 1301 if desired. The user can then either select to perform a wash step or to perform an elution. Alternatively, depending on the use-case, CPT pore size, and on the Concentrating Pipette instrument protocol, the user may remove sample port cap 1302 immediately prior to or after inserting CPT 1301 into manifold 1303. Further, in some cases the user may wish to remove cap 1302 immediately after initiating the sample processing run. The order of cap removal can be changed as described to improve workflow and to reduce the chance of drips coming from CPT 1301 sample port. Additionally, the CP Select control software can be configured, or a dedicated elution instrument can be programmed, to enable a protocol wherein immediately after insertion of CPT 1301 into manifold 1303, and initiation of the sample processing run by the user, a permeate pump is turned on and then off again to create negative pressure within the CPT 1301 permeate. The user may then remove sample port cap 1302.

If performing a wash step the instrument will guide the user through several steps including placing the wash fluid under CPT 1301 and lowering the manifold head so that CPT 1301 is in the wash fluid. A range of wash fluids can be used as was described earlier in this application. After the wash step is complete the user will then be guided through the elution process including holding a container under CPT 1301 and hitting the elute button. After elution the sample can be processed, extracted and analyzed using appropriate procedures.

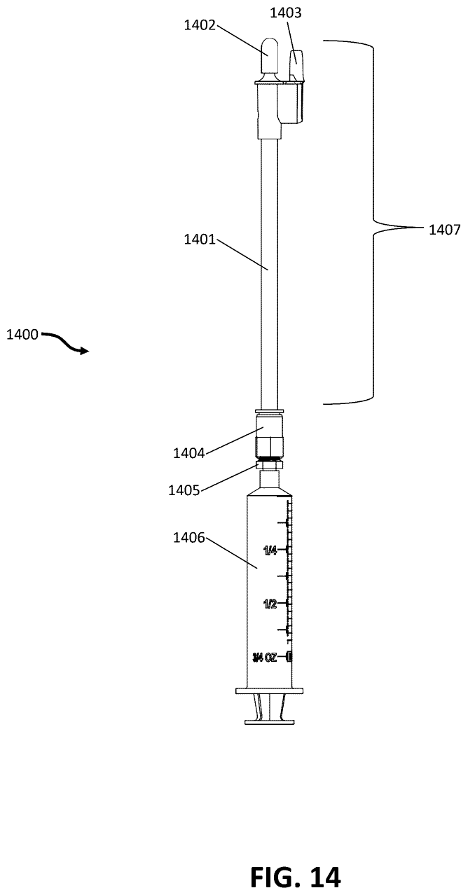

FIG. 14 shows an external view of a sample recovery system 1400 for recovering concentrated samples from CPT 1407, having hollow fiber membrane filters, with a push-to-connect type fitting 1404 and sample recovery syringe 1406 attached to the CPT sample port, according to an exemplary embodiment of the present subject disclosure.

The disclosed system is used after field or remote collection onto CPT 1407 using approaches disclosed in FIG. 4, FIG. 5, FIG. 6, FIG. 7. and FIG. 10 and the transport buffer injection procedure described in FIG. 11. CPT 1407 is received by a laboratory with transport buffer in the retentate and permeate chambers and caps over the elution fluid or retentate port, permeate port, and sample port. CPT 1407 is first held in a vertical position with the sample port at the top and the elution fluid or retentate port and permeate port at the bottom. The sample port cap is then removed and the assembled syringe 1406, Luer lock fitting 1405, and push-to-connect fitting 1404 are pushed onto filter housing 1401 of CPT 1407. Alternatively, a slip fit of rubber of flexible plastic may be used in place of a push-to-connect type fitting, in order to provide a more affordable alternative to this fitting type.

The entire assembly of the sample recovery system 1400 is then flipped over such that syringe 1406 is at the bottom, as is shown in FIG. 14. The elution fluid or retentate port cap 1402 and the permeate port cap are then removed and the plunger of syringe 1406 is drawn back and held drawn back for a period of 1 to 10 seconds until dripping into syringe 1406 has nearly stopped. After recovery of the sample it can then be processed, extracted and analyzed using appropriate procedures. This approach enables capture of target particles or target nucleic acids or proteins into a small volume of transport buffer. This approach enables recovery of these materials regardless of if the transport buffer lyses or does not lyse the target bacteria, viruses or parasites.

Alternatively, the approach described in FIG. 14, an instrument may be used which pushes a fluid into both permeate port 1403 and the retentate port of CPT 1407 and thereby pushes the recovered sample out of the bottom sample port of CPT 1407, as will be well understood by those skilled in the art. The fluid that is pushed into permeate port 1403 and the retentate port of CPT 1407 may be air or a liquid buffer. This approach and the syringe recovery approach described for FIG. 14 both enable recovery of target bacteria, viruses, or parasites, or nucleic acids from these targets, in the case that the transport buffer causes lysis of the target microorganisms.

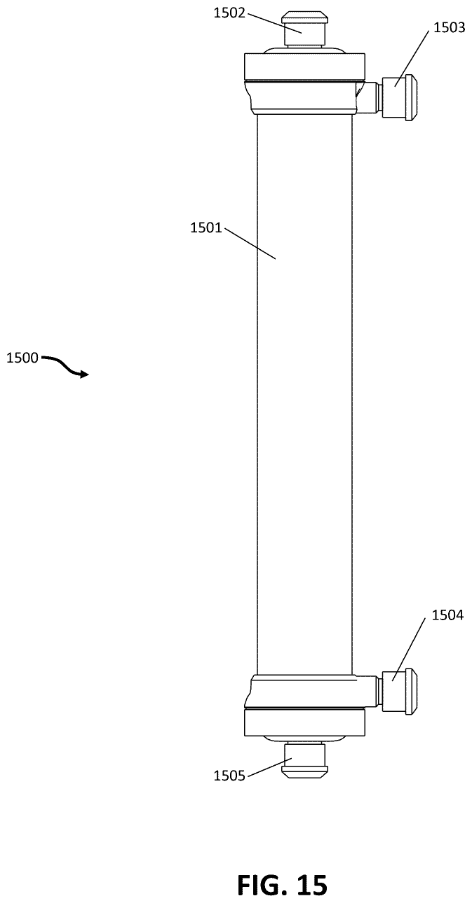

FIG. 15 shows an external view of a large volume sampling assembly 1500 having a large volume concentration module 1501 with hollow fiber membrane filters, with transport caps in place, according to an exemplary embodiment of the present subject disclosure. The large volume sampling assembly 1500 uses a large dialyzer-type hollow fiber module, called a large volume concentration module 1501, herein, which can be sampled onto using approaches like those described in FIG. 4, FIG. 5, FIG. 6, FIG. 7. and FIG. 10 and can then be transported or shipped on ice to a laboratory. Alternatively, methods similar to those described in FIG. 11 can be used to fill large volume concentration module 1501 with a transport media prior to transport or shipping, as will be understood by those skilled in the art. Although the large volume concentration module 1501 is considerably larger than the CPT described in FIG. 11 the hollow fiber module has a smaller internal diameter, so filling the retentate with transport buffer using a syringe is still possible. One method of filling large volume concentration module 1501 with transport buffer is immediately after sampling, but before drawing air into large volume concentration module 1501, the sampling pump is turned off and when liquid stops flowing the sample port or sample port tubing is removed from the sample fluid and placed into a container of transport buffer, the pump is then turned back on and the transport buffer fluid is drawn into large volume concentration module 1501. Prior to transport retentate cap 1502, permeate caps 1503 and 1504, and sample port cap 1505 are place over the appropriate ports. Alternatively, to the large dialyzer-type hollow fiber module described, much smaller, or even larger, hollow fiber or flat membrane filter modules can be used in a similar manner, as will be well understood by those skilled in the art. Hollow fiber and flat membrane filter modules used in this case can range from as small as 1 cm² membrane filter surface area to as much as 100 m², or more specifically from 5 cm² to 10 m². This range of sizes allows for use in a range of applications, requiring differing sample volumes to be processed. Possible applications include those generally requiring smaller sample volumes, such as legionella detection in cooling tower water, detection in indicator organisms in recreational waters, and detection of pathogens for wastewater surveillance, each of which generally require less than 1 Liter of sample to be concentrated in most cases. These applications, in general will require smaller membrane filter surface areas. Applications that generally require much large sample volumes to be concentrated include detection of pathogens in drinking water, including viral pathogens and Cryptosporidium and Giardia. These applications will require much larger surface area modules, in most cases, as will be well understood by those skilled in the art. A significant number and type of other possible applications, for both large surface area and small surface area membrane filter modules are possible, as will be well understood by those skilled in the art.

Hollow fiber and flat membrane filter modules used can be constructed with membrane filters of a range of pore sized, depending on the application requirements. Pore sizes can range from 0.01 μm to 3.0 μm or more for capture of bacteria, parasites, molds, spores, and whole cells, and more specifically from 0.1 μm to 0.45 μm for most bacteria. Larger pore sizes can be used in the case of some parasites, such as Cryptosporidium and Giardia, where pore sizes ranging from 0.45 to 3.0 μm are usable, as will be well understood by those skilled in the art. Further, pore sizes in these ranges may also be used for capture of plastic microparticles and nanoparticles, as will be well understood by those skilled in the art. Ultrafiltration for virus and free DNA may also be conceivable to those having ordinary skill in the art in light of this disclosure. Further any filter or membrane filter in the standard range of ultrafiltration or microfiltration membrane filters as well as fibrous filters and filters with mechanisms for attraction, such as zeta potential filters, may be used in a membrane filter module for capture of particles ranging from less than 1 kD molecular weight or less than 0.001 μm to particles or organisms up to as large as 1 mm in diameter. Ultrafiltration membranes in the range of 1 kD to 1,000 kD can be used in CPTs for a variety of concentration applications including proteins and other soluble and insoluble materials and small particles including pyrogens. Free DNA, and free RNA may be captured and concentrated using filters in the approximate range of 0.001 μm to 0.02 μm or 1 kD to 300 kD. Virus may be captured and concentrated using filters generally in the physical or effective pore size range of 0.001 μm to 0.1 μm or in the general molecular weight cut-off range of 1 kD to 1,000 kD. Bacteria can be concentrated using membranes generally in the range of 0.01 to 0.5 μm. Moreover, any membrane with a physical or effective pore size sufficiently small enough to capture the particle of interest may be used and in some instances pore size significantly smaller than the target particle may be selected such that multiple targets, of different sizes may be concentrated into a single concentrated sample. Further, as can be appreciated by someone skilled in the art, novel membranes and filters, and membranes and filters other than those mentioned here, may serve the purpose of retaining certain particles of interest and may provide a reliable filter for use in a CPT.

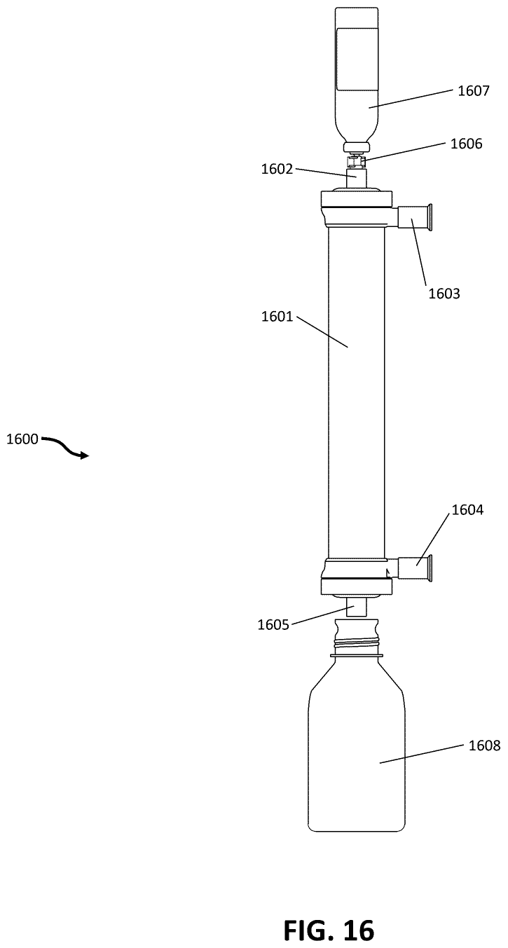

FIG. 16 shows an external view of a recovery system 1600 for a large volume concentration module 1601 having hollow fiber membrane filters with permeate port transport caps in place with an elution in progress, according to an exemplary embodiment of the present subject disclosure. This embodiment is used to elute concentrated samples from large volume concentration module 1601 after sample collection in the field as described in FIG. 15.

Upon receipt of large volume concentration module 1601 by the laboratory it is removed from the packaging and is placed onto a ring stand clamp or other holder to hold it in a vertical position with sample port 1605 in the down position and elution fluid or retentate port 1602 in the up position. Sample elution fitting 1606 is then threaded into elution fluid or retentate port 1602 and a sample container 1608 is placed under sample port 1605. An elution fluid canister 1607, containing a commercially available elution fluid formulation, from InnovaPrep or a custom formulated elution fluid canister is then pushed firmly into sample elution fitting 1606.

A wet foam is then released from elution fluid canister 1607 and travels through the retentate chamber within large volume concentration module 1601 and is dispensed out of sample port 1605 and into sample container 1608. The sample is then ready for optional additional concentration using a Concentrating Pipette instrument and preparation, extraction, and analysis.

Alternatively, to those approaches described for FIG. 16, an instrument may be used to push which pushes a fluid into both retentate port 1602 and one or both of the permeate ports of large volume concentration module 1601 and thereby pushes the recovered sample out of the sample port 1605 and into sample container 1608, as will be well understood by those skilled in the art. The fluid that is pushed into retentate port 1602 and one or both of the permeate ports of large volume concentration module 1601 may be air or a liquid buffer. This approach and the syringe recovery approach described for FIG. 16 both enable recovery of target bacteria, viruses, or parasites, or nucleic acids from these targets, in the case that the transport buffer causes lysis of the target microorganisms.

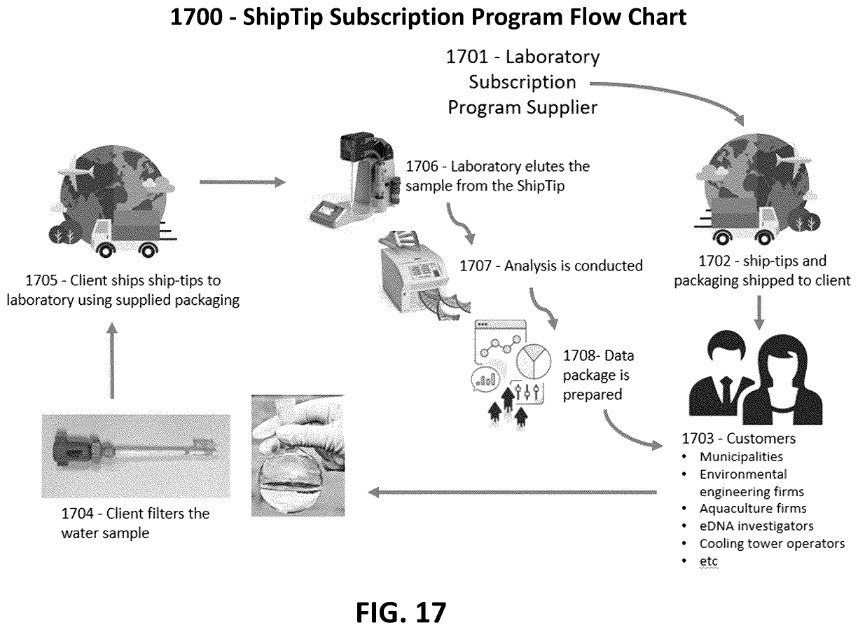

FIG. 17 shows a flow schematic of a sample analysis subscription program 1700 using ship-tip CPTs, according to an exemplary embodiment of the present subject disclosure. In step 1701, the program starts with ship-tip CPTs consumable materials, as well as sampling equipment, being provided by the Laboratory Subscription Program. In 1702, the Laboratory Subscription Program Supplier ships ship-tips and packaging to clients. 1703, shows the customers that will receive the ship-tips and packaging, including municipalities, environmental engineering firms, eDNA investigators, cooling tower operators, and many other users that have a need for field or remote collection followed by concentration and analysis for target microorganisms, viruses, and other particles.

In step 1704, the clients use the provided supplies and equipment to filter water or other samples. In step 1705, the client then packages the ship-tip CPTs and ships them to the appropriate laboratory supplier. This step is can be performed with an overnight or two-day cold shipment without a transport buffer or a transport buffer may be used. With a transport buffer the sample may still be cold shipped on wet ice, frozen, or it may be shipped at room temperature depending on the targets and the transport buffer used. In step 1706, the laboratory receives the ship-tip CPTs and elutes the concentrated sample. In 1707, the laboratory then performs additional processing, extraction and analysis steps. In step 1708, the laboratory prepares a data package and electronically delivers it to the costumer.

For the purposes of this disclosure, a permeate chamber is any volume that is formed between a permeate surface of a membrane and a housing of the CPT, and a retentate chamber is any volume that is formed between a retentate surface of a membrane and said housing. For a dual-filter CPT, a retentate chamber may be formed between the retentate surfaces, and a permeate chamber may be formed between each permeate surface and its respective housing. In a hollow fiber filter CPT, the permeate chamber may be formed by the combined volume external to each hollow fiber filter, and the retentate chamber may be formed by the combined inner volume of each hollow fiber filter. In alternative embodiments, the positions and configurations of the permeate and retentate chambers may be reversed.

The foregoing instrumentalities have significant utility in disease surveillance, environmental, metagenomic research, security, and many other applications. In exemplary embodiments, concentration in the manner described facilitates aerosol sampling for pathogens or bioterrorism threat agents that can withstand being placed in a liquid sample for analysis. A list of such pathogens may be provided, for example, as recognized by the Center for Disease Control (CDC). See TABLE 1 and TABLE 2. See TABLE 3 for agents and sizes. These organisms may be studied using conventional techniques that are facilitated by the concentration of samples as described above.

TABLE 2
CDC CATEGORY A AND B BIOTERRORISM AGENTS LIST

CATEGORY A
Anthrax (Bacillus anthracis)
Botulism (Clostridium botulinum toxin)
Plague (Yersinia pestis)
Smallpox (Variola major)
Tularemia (Francisella tularensis)
Viral hemorrhagic fevers (filoviruses
[e.g., Ebola, Marburg] and arenaviruses
[e.g., Lassa, Machupo])
CATEGORY B
Brucellosis (Brucella species)
Epsilon toxin of Clostridium perfringens
Food safety threats (e.g., Salmonella
species, Escherichia coli O157:H7,
Shigella)
Glanders (Burkholderia mallei)
Melioidosis (Burkholderia pseudomallei)
Psittacosis (Chlamydia psittaci)
Q fever (Coxiella burnetii)
Ricin toxin from Ricinus communis (castor beans)
Staphylococcal enterotoxin B
Typhus fever (Rickettsia prowazekii)
Viral encephalitis (alphaviruses [e.g.,
Venezuelan equine encephalitis, Eastern
equine encephalitis, Western equine encephalitis])
Water safety threats (e.g.,
Vibrio cholerae, Cryptosporidium parvum)

TABLE 3
SECONDARY POTENTIAL BIOLOGICAL THREAT AGENTS

| | |
|---|---|
| Viri/prions | Histoplasma capsulatum |
| Flaviviruses | Cryptococcus neoformans |
| (Yellow fever virus, West Nile | Aspergillus niger |
| virus, Dengue, Japanese | Pathogenic fungi |
| Encephalitis, TBE, etc.) | Acremomium spp. |
| Hepatitis (A, B, C) | Alternaria alternate |
| Prions (CJD, BSE, CWD) | Apophysomyces elegans |
| Alphaviruses (VEE, EEE, WEE) | Aspergillus terreus |
| MERS | Bipolaris spp. |
| SARS | Bipolaris spicifera |
| SARS-CoV-2 | Blastoschizomyces capitatus |
| COVID-19 | Candida krusei |
| Nipah virus | Candida lusitaniae |
| Rabies virus | Cladophialophora bantiana |
| Rhinovirus (could be modified?) | Cunnihamella berholletiae |
| Polioviruses | Curvularia lunata |
| Hantaviruses | Exserohilum rostratum |
| Filoviruses (Ebola, Marburg, Lassa) | Fusarium moniliforme |
| Bacilli | Fusarium solani |
| Mycobacterium tuberculosis, | Hansenula anomala |
| drug resistant | Lasiodilodia theobromae |
| Mycobacteria other | Malassezia furfur |
| than TB, like C. leprae | Paecilomyces lilacinus |
| Streptococcus pneumoniae | Paecilomyces bariotii |
| Streptococcus pyogenes | Penicillium marneffei |
| Streptococcus aureus | Phialemonium curvatum |
| Clostridium tetani | Phialophora parasitica |
| Clostridium difficile | Phialophora richardsiae |
| Bacillus cereus | Ramichloridium spp. |
| Coxiella brunette (Q fever) | Rhizomucor pusillus |
| Francisella tularensis | Rhizopus rhizopodiformus |
| Borrelia recurrentis | Rhodotorula rubra |
| Rickettsia rickettsii | Sacchromyces cerevisiae |
| R. prowazekii | Scedosporium prolificans |
| Shigella sonnei | Trichosporon beigelii |
| Bartonella henselae | (T. asahii) |
| Yersinia enterolitica | Wangiella dermatitidis |
| Yersinia pseudotuberculosis | |
| Neisseria meningitidis | |
| Legionella pneumophila | |
| Burkholderia pseudomallei | |
| Pasturella multocida | |
| Other Pathogenic Microorganisms | |
| Cryptosporidium parvum | |

TABLE 4
PHYSICAL SIZES OF SOME AGENTS AND SURROGATES

| TARGET | PHYSICAL SIZE |
|---|---|
| Bacillus thuringiensis endospore | approximately 1 μm |
| Bacillus anthracis endospore | approximately 1 μm |
| Yersinia pestis | Gram negative rod-ovoid 0.5-0.8 μm in |
| | width and 1-3 μm in length |
| Yersinia rohdei | approximately 1 μm |
| Venezuelan Equine Encephalitis | 70 nm (0.07 μm) |
| Gamma-killed MS2 | 2 mD or about 25 nm (0.025 μm) |
| | (but will pass through a 300 kD |
| | pore size but is retained by a |
| | 100 kD pore size Wick and |
| | McCubbin - ECBC) |
| Ovalbumin | 45 kD or 6 nm (0.006 μm) |
| Botulinum Toxoid A | 150 to 900 kD or 10 nm |
| | to 70 nm (0.01 μm to 0.07 μm) |
| | (Normally published as 150 kD |
| | however some publications |
| | state that toxoid A can be |
| | released as complexes comprised |
| | of the 150 kD toxin protein along with |
| | associated non-toxin proteins and can |
| | therefore be released in 900 kD, |
| | 500 kD, and 300 kD forms. |
| DNA | 1000 Bp or 600 kD up to 15,000 |
| | Bp or 9 mD |

The concentrating pipette tips (CPTs) used in this disclosure may be any disposable filter tip, for instance, an irradiated 0.2 micron polysulfone hollow fiber CPT which is sold by Assignee under part numbers CC08022-10, or an irradiated ultrafilter polysulfone hollow fiber CPT which is sold by Assignee under part numbers CC08003-10. Exemplary particle size capabilities are dependent on the CPT used, and pore sizes can range from 0.01 μm-0.45 μm or more for capture of bacteria, parasites, molds, spores, and whole cells. Ultrafiltration for virus and free DNA may also be conceivable to those having ordinary skill in the art in light of this disclosure. Further any filter or membrane filter in the standard range of ultrafiltration or microfiltration membrane filters as well as fibrous filters and filters with mechanisms for attraction, such as zeta potential filters, may be used in a CPT device for capture of particles ranging from less than 1 kD molecular weight or less than 0.001 μm to particles or organisms up to as large as 1 mm in diameter. Ultrafiltration membranes in the range of 1 kD to 1,000 kD can be used in CPTs for a variety of concentration applications including proteins and other soluble and insoluble materials and small particles including pyrogens. Free DNA, and free RNA may be captured and concentrated using filters in the approximate range of 0.001 μm to 0.02 μm or 1 kD to 300 kD. Virus may be captured and concentrated using filters generally in the physical or effective pore size range of 0.001 μm to 0.1 μm or in the general molecular weight cut-off range of 1 kD to 1,000 kD. Bacteria can be concentrated using membranes generally in the range of 0.01 to 0.5 μm. Moreover, any membrane with a physical or effective pore size sufficiently small enough to capture the particle of interest may be used and in some instances pore size significantly smaller than the target particle may be selected such that multiple targets, of different sizes may be concentrated into a single concentrated sample. Further, as can be appreciated by someone skilled in the art, novel membranes and filters, and membranes and filters other than those mentioned here, may serve the purpose of retaining certain particles of interest and may provide a reliable filter for use in a CPT.

Moreover, although exemplary concentrations of bacteria are disclosed, any of the disclosed embodiments may be used to concentrate bacterial pathogens within the blood in exemplary embodiments, after preparation of a blood sample by removal of blood components such as red blood cells, etc. Other applications include food and beverage processing and safety monitoring (of spoilage organisms and pathogens from process waters, liquid samples from food preparation surfaces, product wash waters), environmental monitoring (recreational water monitoring, waste water monitoring, legionella monitoring), drinking water, forensics, pharmaceutical manufacturing, and biodefense.

The foregoing disclosure of the exemplary embodiments of the present subject disclosure has been presented for purposes of illustration and description. It is not intended to be exhaustive or to limit the subject disclosure to the precise forms disclosed. Many variations and modifications of the embodiments described herein will be apparent to one of ordinary skill in the art in light of the above disclosure. The scope of the subject disclosure is to be defined only by the claims appended hereto, and by their equivalents.

Further, in describing representative embodiments of the present subject disclosure, the specification may have presented the method and/or process of the present subject disclosure as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present subject disclosure should not be limited to the performance of their steps in the order written, and one skilled in the art can readily appreciate that the sequences may be varied and still remain within the spirit and scope of the present subject disclosure.

What is claimed is:

1. A method, comprising:
capturing microorganisms from a liquid sample using a concentrating pipette tip, leaving a remaining liquid;
passing the remaining liquid to a permeate outside of the concentrating pipette tip;
placing caps over a retentate port and a permeate port of the concentrating pipette tip resulting in a capped concentrating pipette tip containing captured microorganisms;
packaging and shipping the capped concentrating pipette tip to a laboratory for analysis.

2. The method of claim 1, further comprising:
receiving the capped packaged concentrating pipette tip at the laboratory;
removing the caps from the retentate port and the permeate port; and
inserting the concentrating pipette tip into a concentrating pipette instrument; and
removing the cap from a sample port and eluting the captured microorganisms into a concentrated volume.

3. The method of claim 1, wherein the concentrating pipette tip contains one or more hollow fiber membrane filters.

4. The method of claim 1, wherein the concentrating pipette tip contains one or more flat membrane filters.

5. The method of claim 1, wherein the liquid sample is drawn through the concentrating pipette tip using a pump.

6. The method of claim 1, wherein the liquid sample is pushed through the concentrating pipette tip using a pump or pressure.

7. The method of claim 1, wherein the sample is shipped on wet ice.

8. The method of claim 1, wherein the sample is filled with a transport fluid prior to transport.

9. The method of claim 8, wherein the transport fluid is non-lytic.

10. The method of claim 8, wherein the transport fluid is lytic.

11. The method of claim 8, wherein the sample is shipped on wet ice.

12. The method of claim 8, wherein the sample is shipped at room temperature.

13. The method of claim 1, further comprising:
receiving the capped packaged concentrating pipette tip at the laboratory;
removing the caps from the retentate port, permeate port, and a sample port;
attaching a syringe to the sample port; and
holding the concentrating pipette tip vertically with the sample port down and drawing a sample of the captured microorganisms into the syringe.

14. The method of claim 1, further comprising:
receiving the capped packaged concentrating pipette tip at the laboratory;
removing the caps from the retentate port, permeate port, and a sample port; and
pushing a fluid into the retentate port and permeate port, thereby pushing a sample of the captured microorganisms out of the concentrating pipette tip and into a sample container.

15. A method, comprising:
capturing microorganisms from a liquid sample using a membrane filter module, leaving a remaining liquid;
passing the remaining liquid to a permeate outside of the membrane filter module;
placing caps over all ports of the membrane filter module resulting in a capped membrane filter module containing captured microorganisms; and
packaging and shipping the capped membrane filter module to a laboratory for analysis.

16. The method of claim 15, further comprising:
receiving the capped packaged membrane filter module at the laboratory;
removing the caps from the ports; attaching a syringe to a bottom port while holding the module vertically; and
drawing a sample of the captured microorganisms into the syringe.

17. The method of claim 15, further comprising:
receiving the capped packaged membrane filter module at the laboratory;
removing the caps from all ports; and
pushing a fluid into the retentate port and the permeate port, while holding the membrane filter module vertically, thereby pushing a sample of the captured microorganisms out of the membrane filter module and into a sample container.

18. The method of claim 15, wherein the membrane filter module contains one or more hollow fiber membrane filters.

19. The method of claim 15, wherein the sample is shipped on wet ice.

20. The method of claim 15, wherein the sample is filled with a transport fluid prior to transport.
